(19) United States
(12) Patent Application Publication
(10) Pub. No.: US 2026/0264510 A1
(43) Pub. Date: Sep. 10, 2026

(54) DRIVE APPARATUS, AXLE, GEAR HOUSING ASSEMBLY AND WORK MACHINE

(71) Applicant: DEERE & COMPANY, MOLINE, IL (US)

(72) Inventor: MANUEL MANN, Hüffenhardt (DE)

(21) Appl. No.: 19/422,833

(22) Filed: Dec. 17, 2025

(30) Foreign Application Priority Data
Mar. 10, 2025 (EP) 25162490.4

(51) Int. Cl. B60K 17/08; B60K 1/02

(52) U.S. Cl. CPC B60K 17/08; B60K 1/02; B60Y 2200/221

(57) ABSTRACT

A drive apparatus for a work machine includes a drive input, a drive output, a first and second energy machine, and a first transmission unit having a first and second input and a first and second output, wherein the drive input is connectable to the drive output via the first transmission unit, the first energy machine is connectable to the first input by a first shift element, and the second energy machine is connected to the second input.

### CROSS-REFERENCE TO RELATED APPLICATIONS

This application claims priority to European Patent Application No. 25162490.4, filed Mar. 10, 2025, which is hereby incorporated by reference.

### FIELD OF THE DISCLOSURE

The disclosure relates to a drive apparatus, an axle, a gear housing assembly, and a work machine.

### BACKGROUND

Work machines, for example construction machines or agricultural work vehicles, particularly for example agricultural towing vehicles or farm tractors or tractors, are commonly powered by engines. In this context, the engine can drive one or more axles or vehicle axles of the work machine, for example a rear axle and/or a front axle. The axle(s) is (are) usually driven by the crankshaft of the engine via a gear having a variable transmission ratio and via one or more differentials. The differential(s) can be connected in terms of drive on the driven side to the vehicle axles, for example to the shafts of the wheels, for example the front and/or rear wheels.

### SUMMARY

In addition, the work machine can likewise have a first power output, for example a mechanical power output, particularly for example a power take-off unit. The first power output can be situated on a rear side of the work machine, for example in the vicinity of an attachment interface for implements. In addition, the drive apparatus or the work machine can comprise a second power output, for example a further power take-off unit. The second power output can be connected to the drive input and/or can be situated on a front side of the work machine.

There are currently proposals for powering work machines of this kind by means of electric motors, for example as purely battery-operated vehicles. An obvious approach that is conventional in the art would be to transfer the existing drivetrain (constructed with a shaft extending in the longitudinal direction, but now driven by electric motor, and with a differential) to such vehicles, as disclosed in EP 4 227 192 A1.

According to an aspect of the present disclosure, a drive apparatus for a work machine includes a drive input, a drive output, a first and second energy machine, and a first transmission unit having a first and second input and a first and second output, wherein the drive input is connectable to the drive output via the first transmission unit, the first energy machine is connectable to the first input by a first shift element, and the second energy machine is connected to the second input.

According to an aspect of the present disclosure, the first transmission unit comprises a planetary coupling gear, for example having two different stationary transmission ratios, and the first transmission unit comprises at least one first and second planetary gear, wherein the planetary gears are coupled to one another.

According to an aspect of the present disclosure, the first input is connectable or connected to a first annulus of the first planetary gear and to a second planet carrier of the second planetary gear, the second input is connected to a first sun wheel of the first planetary gear, the first output is connectable or connected to a first planet carrier of the first planetary gear and to a second annulus of the second planetary gear, and the second output is connected to the second sun of the second planetary gear.

According to an aspect of the present disclosure, the first energy machine is designed as a first electric motor, and the second energy machine is designed as a second electric motor.

According to an aspect of the present disclosure, the drive apparatus comprises a second transmission unit including a first cylindrical gear stage and a second cylindrical gear stage and a third planetary gear, and at least one second and third shift element, and the second transmission unit has two inputs and at least one third output.

According to an aspect of the present disclosure, the second transmission unit is arranged downstream of the first transmission unit in the power flow.

According to an aspect of the present disclosure, the drive apparatus comprises power electronics.

According to an aspect of the present disclosure, the first and second transmission units have a passage for the drive input.

According to an aspect of the present disclosure, the first energy machine is connectable to a first power output.

According to an aspect of the present disclosure, the drive output and the first transmission unit are connectable to a countershaft.

According to an aspect of the present disclosure, the drive apparatus comprises a control unit (e.g., a controller including a processor and memory).

According to an aspect of the present disclosure, an axle comprises the drive apparatus of any of the preceding embodiments.

According to an aspect of the present disclosure, a gear housing assembly comprising the drive apparatus of any of the preceding embodiments, wherein the gear housing assembly comprises a first housing module with the first transmission unit, wherein the first housing module has an input-side housing wall and an output-side housing wall, and the input-side housing wall of the first housing module has at least one first input opening, and the output-side housing wall of the first housing module has a first output opening, and the gear housing assembly comprises a second housing module with the second transmission unit, wherein the second housing module has an input-side housing wall and an output-side housing wall, and the input-side housing wall of the second housing module has at least one further input opening, and the output-side housing wall of the second housing module has at least one further output opening.

According to an aspect of the present disclosure, a work machine comprises the gear housing assembly of any of the preceding embodiments.

According to an aspect of the present disclosure, the work machine comprises two frame elements, wherein the gear housing assembly is arranged at least partially on the frame elements.

The above and other features will become apparent from the following detailed description and accompanying drawings.

### BRIEF DESCRIPTION OF THE DRAWINGS

The disclosure and other advantages and advantageous developments and refinements of the disclosure, both in terms of hardware and in terms of method, will be explained in greater detail below on the basis of example embodiments and with reference to the drawing. Component parts of equivalent or comparable function are designated here by the same reference signs. In the drawings:

FIG. 1 shows a schematic illustration of a first example embodiment of a work machine according to the disclosure having a drive apparatus according to the disclosure;

FIG. 2 shows a schematic illustration of the first example embodiment of the drive apparatus according to the disclosure;

FIG. 3 shows a schematic illustration of a second example embodiment of the drive apparatus according to the disclosure;

FIG. 4 shows a schematic illustration of a third example embodiment of the drive apparatus according to the disclosure;

FIG. 5 shows a detailed illustration of a further example embodiment of the first transmission unit;

FIG. 6 shows a detailed illustration of a further example embodiment of the second transmission unit;

FIG. 7 shows a detailed illustration of the second transmission unit according to FIG. 4;

FIG. 8 shows a schematic illustration of a first example embodiment of a gear housing assembly according to the disclosure;

FIG. 9 shows a schematic illustration of a second example embodiment of a gear housing assembly according to the disclosure;

FIG. 10 shows a schematic illustration of a third example embodiment of a gear housing assembly according to the disclosure;

FIG. 11 shows a schematic illustration of a fourth example embodiment of a gear housing assembly according to the disclosure;

FIG. 12 shows a schematic illustration of a fifth example embodiment of a gear housing assembly according to the disclosure;

FIG. 13 shows a schematic illustration of a sixth example embodiment of a gear housing assembly according to the disclosure; and

FIG. 14 shows a schematic illustration of a further example embodiment of a work machine according to the disclosure having a gear housing assembly and drive apparatus according to the disclosure.

Like reference numerals are used to indicate like elements throughout the several figures.

### DETAILED DESCRIPTION

The embodiments or implementations disclosed in the above drawings and the following detailed description are not intended to be exhaustive or to limit the present disclosure to these embodiments or implementations.

Proceeding from the prior art, it is an object of the present disclosure to propose a drive apparatus, an axle, a work machine, and a gear housing assembly that are improved in comparison with the prior art. More specifically, it can be an object of the present disclosure to propose a drive apparatus and/or an axle and/or a work machine and/or a gear housing assembly which are of structurally simpler and/or more compact and/or more modular configuration and/or are electrically operable and/or electrically drivable.

This object is achieved by a drive apparatus having the features of one or more embodiments disclosed herein, an axle having the features of one or more embodiments disclosed herein, a gear housing assembly having the features of one or more embodiments disclosed herein, and a work machine having the features of one or more embodiments disclosed herein. One or more embodiments disclosed herein relate to particularly advantageous embodiments of the disclosure.

According to the disclosure, a drive apparatus for a work machine and/or an axle is proposed. The drive apparatus comprises a drive input, for example a drive shaft or input shaft, and a drive output, for example a driven shaft or output shaft, and a first and second energy machine. The drive apparatus further comprises a first transmission unit, wherein the first transmission unit has a first and second input and a first and second output. The drive input is connectable or connected to the drive output via the or by the first transmission unit or the first and a second transmission unit. The first energy machine is connectable or connected to the first input by a first shift element, and the second energy machine is connected to the second input. For example, the first transmission unit can comprise one or more planetary gears.

The term “connected” can be understood as meaning for example mechanically connected and/or mechanically operatively connected. For example, “connected” can be understood, additionally or alternatively, as drivably connected, that is, torque-transmittingly and/or rotational speed-transmittingly connected, and/or coupled, that is, for example mechanically coupled and/or rigidly coupled, and/or coupled for conjoint rotation. The term “connectable” can be understood as meaning for example mechanically connectable and/or mechanically operatively connectable. For example, “connectable” can be understood, additionally or alternatively, as drivably connectable, that is, torque-transmittingly and/or rotational speed-transmittingly connectable, and/or couplable, that is, mechanically couplable and/or rigidly couplable, and/or connectable for conjoint rotation. The term “connected” can therefore for example be understood as a connection of two components which makes it possible to transmit energy and/or force and/or a torque and/or a rotational speed from one component to the other, for example mechanically. Further components or parts enabling such a transmission of energy and/or force and/or torque and/or transmission of a rotational speed between the two components can be provided between the two components.

A “shift element”, for example a first and/or second and/or third and/or fourth and/or fifth and/or sixth and/or seventh shift element and/or further shift elements, can be understood as meaning a connecting part by means of which at least one part that transmits energy and/or force and/or a torque and/or a rotational speed is connectable with driving effect to a further part that transmits energy and/or force and/or a torque and/or a rotational speed or to a part that is in a fixed location or fixed to a housing. The respective shift element is shiftable between at least one open and one closed state, wherein, in the open state, the shift element cannot transmit energy and/or force and/or a torque and/or a rotational speed between two parts interacting with the shift element, and wherein, in the closed state, the shift element can transmit energy and/or force and/or a torque and/or a rotational speed between the two parts interacting with the shift element. If there is a connection, for example an operative connection, between two elements or components of the drive apparatus, energy and/or force and/or a torque and/or a rotational speed are/is transmitted from one element or one component to the other element or the other component. A shift element, for example the first and/or second and/or third and/or fourth and/or fifth and/or sixth and/or seventh shift element, can be a clutch, for example a multiplate clutch, and/or a brake and/or a synchronizer and/or a dog clutch.

In the text which follows, an input, for example the first and/or the second and/or a third and/or fourth input, can be a mechanical power interface by means of which a force and/or a torque and/or a rotational speed can be introduced, for example into the transmission units, particularly for example into the first transmission unit and/or the second transmission unit. In the text which follows, an output, for example the first and/or second and/or third and/or a fourth output, and/or the drive output and/or the countershaft can be a mechanical power interface by means of which a force and/or a torque and/or a rotational speed can be output, for example from the transmission units, particularly for example from the first transmission unit and/or the second transmission unit.

The first output can comprise a first driving element or can be designed as a first driving element. The second input can comprise a second driving element or can be designed as a second driving element. The first and/or second input, for example the first and/or second driving element, can be designed as a shaft or a gearwheel and/or a shift element, for example, and/or can comprise these. The first output can comprise a first driven element or can be designed as a first driven element. The second output can comprise a second driven element or can be designed as a second driven element. The first and/or second output, for example the first and/or second driven element, can be designed as a shaft and/or a gearwheel and/or a shift element, for example, and/or can comprise these.

The first input can be designed for input-side attachment and/or connection of the first transmission unit to the first variator or a driven component of the drive apparatus. The second input can be designed for input-side attachment and/or connection of the first transmission unit to the first variator or a driven component of the drive apparatus. Via the first and/or second input, a force and/or a torque and/or a rotational speed are/is introducible into the first transmission unit or transmissible to the latter.

The first and/or second output can be designed for output-side attachment, for example to the drive output or the second transmission unit. The first transmission unit can be connectable or connected to the second transmission unit and/or the drive output, for example the output shaft, by means of the or by the first and/or second output. Via the first and/or second output, a force and/or a torque and/or a rotational speed can be introducible into the second transmission unit and/or the drive output, for example the output shaft, or transmissible to the latter.

The drive input, for example the input shaft or drive shaft, can be connected to the first shift element. The first energy machine can be connected to the first shift element by means of the or by the drive input. The first energy machine can be connected to the drive input directly or via a or by means of a or by a first transmission stage, for example a third cylindrical gear stage or a first gearwheel pair or three or more gearwheels or a fourth planetary gear or some other gear. The first energy machine can be connectable or connected to the first input by the or via the or by means of the drive input and via the or by means of the first shift element. However, the first energy machine can also be connectable to the first input directly via the or by means of the first shift element. The second energy machine can be connected to the second input directly or via a or by means of a or by a second transmission stage, for example a fourth cylindrical gear stage or a second gearwheel pair or three or more gearwheels or a fifth planetary gear or some other gear. The first energy machine can be a first variator, and/or the second energy machine can be a second variator. The first energy machine and the first shift element can be connected to the drive input.

The drive input, for example the drive shaft or input shaft, and/or the drive output, for example the driven shaft or output shaft, can be a solid shaft. The drive input and the drive output can be arranged coaxially with one another. The drive output can be connected to a travel drive. More specifically, the drive output can be connected to the travel drive by means of one or more or by one or more further transmission stages. The one or more further transmission stages can be designed as further cylindrical gear stages and/or further gearwheel pairs and/or three or more gearwheels and/or further planetary gears or other gears.

The drive apparatus or, for example, the work machine or the axle can comprise the travel drive, for example a front axle drive and/or a rear axle drive. The drive output can be connected to the travel drive, for example the front axle drive and/or the rear axle drive. The travel drive can comprise a first vehicle axle or front axle and/or a second vehicle axle or rear axle and/or a first differential or a front axle differential and/or a second differential or a rear axle differential and/or the one or more ground-engaging means. The front axle drive can comprise the first vehicle axle or front axle and/or the first differential or the front axle differential and/or the one or more ground-engaging means. The rear axle drive can comprise the second vehicle axle or rear and/or the second differential or the rear axle differential and/or the one or more ground-engaging means. The first differential can be connectable or connected on the driving side to the drive output and/or the countershaft. In addition, the first differential can be connectable or connected on the driven side to the first vehicle axle, for example to a left-hand shaft and to a right-hand shaft in order to drive ground-engaging means. The second differential can be connectable or connected on the driving side to the drive output and/or the countershaft. In addition, the second differential can be connectable or connected on the driven side to the second vehicle axle, for example to a left-hand shaft and to a right-hand shaft in order to drive ground-engaging means.

The drive apparatus and/or the work machine and/or the axle can comprise a control unit. The control unit can be connected to the first and/or second energy machine by signals, and/or operatively coupled thereto and/or connected thereto for transmitting signals and/or carrying data. The control unit can be configured to receive one or more rotational speed signals and/or torque signals from the drive apparatus, for example from one or more rotational speed and/or torque sensors of the drive apparatus, and/or from the first and/or second energy machine. The control unit can be configured to ascertain a rotational speed and/or a torque by means of the rotational speed signal and/or the torque signal. The control unit can be configured to set and/or adjust the rotational speed and/or the torque of the drive apparatus, for example of the first and/or second energy machine, for example to set and/or adjust a specifiable rotational speed and/or a specifiable torque. The control unit can be configured to set and/or adjust the rotational speed of a first and/or second power output.

The shift elements can be connected to the control unit by signals, and/or operatively coupled thereto and/or connected thereto for transmitting signals and/or carrying data. For example, each shift element can comprise a valve or a valve assembly, for example a control valve, or an actuator for operating and/or setting and/or adjusting the respectively associated shift element. The valve or the valve assembly or the actuator can be connected and/or operatively coupled to the respectively associated shift element. The control unit can be connected to the valve or to the valve assembly or to the actuator of the respectively associated shift element by signals, and/or operatively coupled thereto and/or connected thereto for transmitting signals and/or carrying data. The control unit can be configured to control and/or set and/or adjust the shift element, for example via the or by means of the respectively associated valve or the valve assembly or the actuator. The control unit can be configured to set and/or adjust the shift element, for example via the or by means of the respectively associated valve or the valve assembly or the actuator, into the first position, i.e. the open state, or the second position, i.e. the closed state, for example also to move said shift element from the first into the second position and vice versa.

More specifically, the drive apparatus can be suitable for the axle, for example can be an electrically and/or hydraulically driven axle. Moreover, the drive apparatus can be arranged on and/or in the axle. More specifically, the drive apparatus can be suitable for the work machine, for example can be an electrically and/or hydraulically driven work machine. Moreover, the drive apparatus can be arranged on and/or in the work machine.

It is essential for the disclosure that the first energy machine is connectable, for example releasably connectable, to the first input of the first transmission unit via the or by means of the first shift element. One significant advantage of this disclosure is that, when the first shift element is open, the first energy machine can drive the first power output independently of the second energy machine and, at the same time, the second energy machine can drive the drive output and/or the countershaft and/or the travel drive independently of the first energy machine. It is advantageous that, when the first shift element is closed, the first and the second energy machine can simultaneously drive the drive output and/or the countershaft and/or the travel drive, for example can exclusively drive the drive output and/or the countershaft and/or the travel drive.

In addition, it is possible, when the first shift element is closed, for power to be transmitted to the first power output with a constant rotational speed of the first energy machine and, at the same time, by changing the rotational speed at the second energy machine, for a rotational speed of the drive apparatus, for example of the first and/or second transmission unit, and/or of the drive output and/or of the countershaft and/or of the travel drive, that is infinitely variable, starting from zero, to be set and/or adjusted. In addition, it is advantageously possible simultaneously to transmit power to the drive apparatus, for example the first and/or second transmission unit, and/or the drive output and/or the countershaft and/or the travel drive. A more efficient and more compact drivetrain can thereby advantageously be made possible. Moreover, a structurally simple drive apparatus can advantageously be achieved.

As a refinement of the disclosure, the first transmission unit comprises a planetary coupling gear. More specifically, the first transmission unit can comprise precisely one planetary coupling gear. For example, the planetary coupling gear can comprise or have two different stationary transmission ratios. Alternatively, or in addition, the first transmission unit can comprise at least or precisely one first and/or second planetary gear, wherein the planetary gears can be coupled to one another. More specifically, the first transmission unit, for example the planetary coupling gear, can alternatively or additionally comprise the first and the second planetary gear, wherein the first and second planetary gears can be coupled to one another. The first and second planetary gears can thus be coupled to one another in such a way that the first transmission unit has the first and second inputs and the first and second outputs. More specifically, a first planet carrier of the first planetary gear can be connected to a second annulus of the second planetary gear, and a first annulus of the first planetary gear can be connected to a second planet carrier of the second planetary gear. Alternatively, the first planet carrier of the first planetary gear can be connected to the second planet carrier of the second planetary gear, and a first annulus of the first planetary gear can be connected to a second annulus of the second planetary gear. The first energy machine can be connectable or connected via the or by the drive input, and the drive input can be connectable or connected via the or by the first shift element, to the first input of the first transmission unit, for example the first input of the planetary coupling gear, particularly for example the first annulus of the first planetary gear and the second planet carrier of the second planetary gear. Alternatively, or in addition, the second energy machine can be connected to the second input of the first transmission unit, for example the second input of the planetary coupling gear, particularly for example the first sun wheel of the first planetary gear. However, the first transmission unit may also be designed as a Ravigneaux set and/or as a Lepelletier gear and/or as some other planetary coupling gear. In other words, therefore, the first and second planetary gears can advantageously be combined to form a planetary coupling gear with four degrees of freedom. The four degrees of freedom can correspond to the first and second inputs and the first and second outputs. The design described with various stationary transmission ratios and/or coupling advantageously allows different transmission ratios and/or modes of the drive apparatus, and, for example, simultaneously allows a compact construction. Furthermore, the abovementioned advantages of the drive apparatus can be achieved.

As a refinement of the disclosure, the first input is connectable or connected to a first annulus of the first planetary gear and/or to a second planet carrier of the second planetary gear. The first input can be the first shift element and/or the first driving element. In other words, the first shift element can be designed as the first input, or can be the first input, and/or can be connected to the first input, for example the first driving element. The first shift element and/or the first driving element can be connected to the first annulus and the second planet carrier. The second input can be connected to a first sun wheel of the first planetary gear. The second input can be the first sun wheel of the first planetary gear and/or the second driving element. In other words, the first sun wheel of the first planetary gear can be designed as the second input, or can be the second input, and/or can be connected to the second input, for example the second driving element. The second energy machine can be connected to the first sun wheel. The first output can be connectable or connected to a first planet carrier of the first planetary gear and/or to a second annulus of the second planetary gear. In other words, the first planet carrier of the first planetary gear and/or the second annulus of the second planetary gear can be designed as the first output, or can be the first output, or can be connected to the first output, for example the first driven element. The second output can be connected to a second sun wheel of the second planetary gear. In other words, the second sun wheel of the second planetary gear can be designed as the second output, or can be the second output, or can be connected to the second output, for example the second driven element. Alternatively, the first input can be connectable or connected to the second annulus of the second planetary gear and the first planet carrier of the first planetary gear, or the first input, for example the first driving element, can be connectable or connected thereto. The first shift element can be connected to the second annulus and the first planet carrier. Alternatively, the first input can be connectable or connected to the second planet carrier of the second planetary gear and the first planet carrier of the first planetary gear, or the first input, for example the first driving element, can be connectable or connected thereto. The first shift element can be connected to the first planet carrier and the second planet carrier. Alternatively, the first input can be connectable or connected to the second annulus of the second planetary gear and the first annulus of the first planetary gear, or the first input, for example the first driving element, can be connectable or connected thereto. The first shift element can be connected to the second annulus and the first annulus. Alternatively, or in addition, the first output can be connectable or connected to the first planet carrier of the first planetary gear and the second planet carrier of the second planetary gear, or the first output, for example the first driven element, can be connectable or connected thereto. Alternatively, or in addition, the first output can be connectable or connected to the first annulus of the first planetary gear and the second annulus of the second planetary gear, or the first output, for example the first driven element, can be connected thereto. This enables the abovementioned advantages of the drive apparatus to be achieved.

As a refinement of the disclosure, the first energy machine is designed as a first electric motor, and the second energy machine is designed as a second electric motor. Alternatively, or in addition, the first and/or second energy machine can be designed as a fuel cell. The first and/or second energy machine can be permanent-magnet and/or electrically excited synchronous and/or asynchronous machines that are operated using direct current and/or three-phase current, particularly for example a permanent-magnet three-phase synchronous machine. The first and/or second energy machine can be operable as motors and/or as generators. The first and/or second energy machine can drive the drive apparatus with a force and/or a rotational speed and/or a torque. The first and/or second energy machine can each comprise a driven shaft, for example a first and second driven shaft.

The first energy machine can be connectable or connected on the driven side, which is to say, for example, by means of the first driven shaft, to the first input, for example the first driving element and/or the first shift element. The second energy machine can be connected on the driven side, which is to say, for example, by means of the second driven shaft, to the second input, for example the second driving element and/or the first sun wheel of the first planetary gear. For this purpose, it is possible, for example, for a first rotor of the first energy machine and/or a second rotor of the second energy machine to be connected to the respective driven shaft. The first and/or second rotor can each be, for example, internal rotors. The first and/or second energy machine can be embodied as a torque motor. The first and/or second energy machine can be designed as a generator.

It is thereby advantageously possible to obtain an electric and/or hydraulic drive apparatus, for example a purely electric or purely hydraulic drive apparatus. Alternatively, or in addition, the first and/or second energy machine can be designed as a hydrostatic variator or as a hydrostat. As a result, the drive apparatus, for example also the axle and/or the work machine, can advantageously be electrically and/or hydraulically, for example purely electrically and/or purely hydraulically, drivable.

As a refinement of the disclosure, the drive apparatus comprises a second transmission unit, and the second transmission unit comprises a first cylindrical gear stage and/or a second cylindrical gear stage and/or a planetary gear, for example a third planetary gear, and at least one second and third shift element. Alternatively, or in addition, the second transmission unit can have two inputs, for example a third and fourth input, and at least one output, for example a third or a third and fourth output.

The third and/or fourth input can be designed for input-side attachment and/or connection of the second transmission unit to the first transmission unit and/or a driven component of the drive apparatus. Via the third and/or fourth input, a torque and/or a rotational speed are/is introducible into the second transmission unit or transmissible to the latter. The third and/or fourth output can be designed for output-side attachment of the second transmission unit. The third and/or fourth output can connect the second transmission unit to a further transmission unit and/or to the drive output, for example the output shaft, or can be connected thereto. Via the third and/or fourth output, a torque and/or a rotational speed can be introducible into a further transmission unit and/or the drive output, for example the output shaft, or transmissible to or at the latter. The third input can comprise a third driving element or can be designed as a third driving element. Alternatively, the first driven element can be the third input and/or can be designed as the third input. It is likewise possible for the first driven element simultaneously to be designed as a third driving element or to be the third driving element. The fourth input can comprise a fourth driving element or can be designed as a fourth driving element. Alternatively, the second driven element can be the fourth input and/or can be designed as the fourth input. It is likewise possible for the second driven element simultaneously to be designed as a fourth driving element or to be the fourth driving element.

The third and/or fourth input, for example the third and/or fourth driving element, can be designed as a shaft or a gearwheel and/or a shift element, for example, and/or can comprise these. The third output can comprise a third driven element or can be designed as a third driven element. The fourth output can comprise a fourth driven element or can be designed as a fourth driven element. The third and/or fourth output, for example the third and/or fourth driven element, can be designed as a shaft and/or a gearwheel and/or a shift element, for example, and/or can comprise these. The third input can be connectable or connected to the second shift element. The third input can be the second shift element. Alternatively, or in addition, the first driven element or the third driving element can be designed as a third input. In other words, the second shift element can be designed as the third input, or can be the third input, and/or can be connected to the third input and/or the first driven element and/or the third driving element. The first output can be connected to the third input. The fourth input can be connectable or connected to the third shift element. The fourth input can be the third shift element. Alternatively, or in addition, the second driven element or the fourth driving element can be designed as a fourth input. In other words, the third shift element can be designed as the fourth input, or can be the fourth input, and/or can be connected to the fourth input and/or the second driven element and/or the fourth driving element. The second output can be connected to the fourth input.

More specifically, the second transmission unit can comprise the following components, for example:
the first cylindrical gear stage and the second and third shift elements and, for example, the third and fourth inputs and the third output (first embodiment), or
the first and second cylindrical gear stages and the second and third shift elements and, for example, the third and fourth inputs and the third and fourth outputs (second embodiment), or
the first cylindrical gear stage and the planetary gear, for example the third planetary gear, and the second and third shift elements and a fourth shift element and, for example, the third and fourth inputs and the third output (third embodiment).

In the first embodiment, the second transmission unit can comprise the first cylindrical gear stage and the second and third shift elements, and:
the third input, for example the second shift element, can be connected to the first output of the first transmission unit, and/or
the fourth input, for example the third shift element, can be connected to the second output of the first transmission unit, and/or
the first output can be connectable or connected to the first cylindrical gear stage by the second shift element, and/or the second output can be connectable or connected to the first cylindrical gear stage by the third shift element, and/or
the second and/or third shift elements can be connectable or connected to the drive output, for example the output shaft, via the or by means of the first cylindrical gear stage.

The third output can be connectable or connected to the first cylindrical gear stage. In other words, the first cylindrical gear stage can be designed as the third output, or can be the third output, and/or can be connected to the third output, for example the third driven element. The first cylindrical gear stage and/or the third output, for example the third driven element, can be connectable or connected to the drive output.

In the first embodiment, six modes per direction of rotation of the drive output 54 of the drive apparatus 20, or in other words in the forward and reverse direction of the drive apparatus 20 or work machine 10 can be obtained by means of the first transmission unit 58 and by means of the second transmission unit 212, comprising the first cylindrical gear stage 320 and the second and third shift elements 324, 326, and optionally a fifth shift element 220 (see below for details) (see Table 1). More specifically, six forward and six reverse gears of the drive apparatus 20 or work machine 10 can be obtained.

TABLE 1
Modes of the first embodiment with the fifth shift element.

| | | | | | | 50 | 56 |
|---|---|---|---|---|---|---|---|
| Forward | Reverse | 210 | 324 | 326 | 220 | (MG1 below) | (MG2 below) |
| Mode 1 | | | X | X | | — | MG2 drives drive |
| | | | | | | | output; rotational speed |
| | | | | | | | MG2 variable |
| Mode 2 | | | X | X | X | MG1 drives first power | MG2 drives drive |
| | | | | | | output; rotational speed | output; rotational speed |
| | | | | | | MG1 fixed | MG2 variable |
| Mode 3 | | X | X | | | MG1 drives drive | MG2 drives drive |
| | | | | | | output; rotational speed | output; rotational speed |
| | | | | | | MG2 variable | MG2 variable |
| Mode 4 | | X | | X | | MG1 drives drive | MG2 drives drive |
| | | | | | | output; rotational speed | output; rotational speed |
| | | | | | | MG2 variable | MG2 variable |
| Mode 5 | | X | X | | X | MG1 drives drive | MG2 drives drive |
| | | | | | | output and/or first | output and/or first |
| | | | | | | power output; | power output; |
| | | | | | | rotational speed | rotational speed |
| | | | | | | MG1 fixed | MG2 variable |
| Mode 6 | | X | | X | X | MG1 drives drive | MG2 drives drive |
| | | | | | | output and/or first | output and/or first |
| | | | | | | power output; | power output; |
| | | | | | | rotational speed | rotational speed |
| | | | | | | MG1 fixed | MG2 variable |
| | Mode 1 | | X | X | | — | MG2 drives drive |
| | | | | | | | output; rotational speed |
| | | | | | | | MG2 variable |
| | Mode 2 | | X | X | X | MG1 drives first power | MG2 drives drive |
| | | | | | | output; rotational speed | output; rotational speed |
| | | | | | | MG1 fixed | MG2 variable |
| | Mode 3 | X | X | | | MG1 drives drive | MG2 drives drive |
| | | | | | | output; rotational speed | output; rotational speed |
| | | | | | | MG2 variable | MG2 variable |
| | Mode 4 | X | | X | | MG1 drives drive | MG2 drives drive |
| | | | | | | output; rotational speed | output; rotational speed |
| | | | | | | MG2 variable | MG2 variable |
| | Mode 5 | X | X | | X | MG1 drives drive | MG2 drives drive |
| | | | | | | output and/or first | output and/or first |
| | | | | | | power output; | power output; |
| | | | | | | rotational speed | rotational speed |
| | | | | | | MG1 fixed | MG2 variable |
| | Mode 6 | X | | X | X | MG1 drives drive | MG2 drives drive |
| | | | | | | output and/or first | output and/or first |
| | | | | | | power output; | power output; |
| | | | | | | rotational speed | rotational speed |
| | | | | | | MG1 fixed | MG2 variable |

The modes can be obtained by opening and closing the shift elements or coupling elements associated with the reference signs indicated and operating the energy machines as illustrated in Table 1. The modes can be obtained by opening and closing the first shift element (reference sign 210) and/or the second shift element (reference sign 324) and/or third shift element (reference sign 326) and/or fifth shift element (reference sign 220) and operating the first and second energy machines (reference signs 50, 56 or MG1 and MG2) as illustrated in Table 1.

In the second embodiment, the second transmission unit comprises the first and second cylindrical gears stages and the second and third shift elements, and in addition or as an alternative to the first embodiment:
the third input, for example the second shift element, can be connected to the first output of the first transmission unit, and/or
the fourth input, for example the third shift element, can be connected to the second output of the first transmission unit, and/or
the first output can be connectable to the first cylindrical gear stage by the second shift element, and the second output can be connectable to the second cylindrical gear stage by the third shift element, and/or
the second shift element can be connectable or connected to the drive output, for example the output shaft, via the or by means of the first cylindrical gear stage, and/or
the third shift element can be connectable or connected to the drive output, for example the output shaft, via the or by means of the second cylindrical gear stage.

The third output can be connectable or connected to the first cylindrical gear stage. In other words, the first cylindrical gear stage can be designed as the third output, or can be the third output, and/or can be connected to the third output, for example the third driven element. The first cylindrical gear stage and/or the third output, for example the third driven element, can be connectable or connected to the drive output.

The fourth output can be connectable or connected to the second cylindrical gear stage. In other words, the second cylindrical gear stage can be designed as the fourth output, or can be the fourth output, and/or can be connected to the fourth output, for example the fourth driven element. The second cylindrical gear stage and/or the fourth output, for example the fourth driven element, can be connectable or connected to the drive output.

In the third embodiment, the second transmission unit comprises the first cylindrical gear stage and the planetary gear, for example the third planetary gear, and the second and the third and the fourth shift element, and in addition or as an alternative to the first and/or second embodiment:
the third input, for example the second shift element, can be connected to the first output of the first transmission unit, and/or
the fourth input, for example the third shift element, can be connected to the second output of the first transmission unit, and/or
the first output can be connectable by the second shift element, and/or the second output can be connectable by the third shift element, to the planetary gear or the third planetary gear, for example a component and/or the same component of the planetary gear or of the third planetary gear, particularly for example the planet carrier of the planetary gear or the third planet carrier of the third planetary gear, and/or
the planetary gear or the third planetary gear, for example a component of the planetary gear or of the third planetary gear, particularly for example the planet carrier of the planetary gear or the third planet carrier of the third planetary gear, can be connected to the first cylindrical gear stage, and/or
the second output of the first transmission unit can be connected to the planetary gear or the third planetary gear, for example a component of the planetary gear or of the third planetary gear, particularly for example the sun of the planetary gear or the third sun of the third planetary gear, and/or
the fourth shift element, which, for example, can be designed as a brake, can be connected to the planetary gear or the third planetary gear, for example a component of the planetary gear or of the third planetary gear, particularly for example the annulus of the planetary gear or the third annulus of the third planetary gear, and/or
the second and/or third shift element can be connectable or connected to the drive output, for example the output shaft, via the or by means of the first cylindrical gear stage, and/or
the planetary gear or the third planetary gear, for example the third planet carrier, can be connectable or connected to the drive output, for example the output shaft, via the or by means of the first cylindrical gear stage.

The third output can be connectable or connected to the first cylindrical gear stage. In other words, the first cylindrical gear stage can be designed as the third output, or can be the third output, and/or can be connected to the third output, for example the third driven element. The first cylindrical gear stage and/or the third output, for example the third driven element, can be connectable or connected to the drive output.

In the third embodiment, eight modes per direction of rotation of the drive output of the drive apparatus, or in other words in the forward and reverse direction of the drive apparatus 20 or work machine 10 can be obtained by means of the first transmission unit and by means of the second transmission unit, comprising the third planetary gear and the first cylindrical gear stage and the second and third and fourth shift elements, and optionally the fifth shift element (see below for details) (see Table 2). More specifically, eight forward and eight reverse gears of the drive apparatus 20 or work machine 10 can be obtained.

TABLE 2
Modes of the third embodiment with the fifth shift element.

| | | | | | | | 50 | 56 |
|---|---|---|---|---|---|---|---|---|
| Forward | Reverse | 210 | 324 | 326 | 602 | 220 | (MG1 below) | (MG2 below) |
| Mode 1 | | | X | X | | | — | MG2 drives drive |
| | | | | | | | | output; rotational |
| | | | | | | | | speed MG2 variable |
| Mode 2 | | | X | X | | X | MG1 drives first | MG2 drives drive |
| | | | | | | | power output; | output; rotational |
| | | | | | | | rotational speed | speed MG2 variable |
| | | | | | | | MG1 fixed | |
| Mode 3 | | X | | X | X | | MG1 drives drive | MG2 drives drive |
| | | | | | | | output; rotational | output; rotational |
| | | | | | | | speed MG2 variable | speed MG2 variable |
| Mode 4 | | X | X | | | | MG1 drives drive | MG2 drives drive |
| | | | | | | | output; rotational | output; rotational |
| | | | | | | | speed MG2 variable | speed MG2 variable |
| Mode 5 | | X | | X | | | MG1 drives drive | MG2 drives drive |
| | | | | | | | output; rotational | output; rotational |
| | | | | | | | speed MG1 variable | speed MG2 variable |
| Mode 6 | | X | | X | X | X | MG1 drives drive | MG2 drives drive |
| | | | | | | | output and/or first | output and/or first |
| | | | | | | | power output; | power output; |
| | | | | | | | rotational speed | rotational speed |
| | | | | | | | MG1 fixed | MG2 variable |
| Mode 7 | | X | X | | | X | MG1 drives drive | MG2 drives drive |
| | | | | | | | output and/or first | output and/or first |
| | | | | | | | power output; | power output; |
| | | | | | | | rotational speed | rotational speed |
| | | | | | | | MG1 fixed | MG2 variable |
| Mode 8 | | X | | X | | X | MG1 drives drive | MG2 drives drive |
| | | | | | | | output and/or first | output and/or first |
| | | | | | | | power output; | power output; |
| | | | | | | | rotational speed | rotational speed |
| | | | | | | | MG1 fixed | MG2 variable |
| | Mode 1 | | X | X | | | — | MG2 drives drive |
| | | | | | | | | output; rotational |
| | | | | | | | | speed MG2 variable |
| | Mode 2 | | X | X | | X | MG1 drives first | MG2 drives drive |
| | | | | | | | power output; | output; rotational |
| | | | | | | | rotational speed | speed MG2 variable |
| | | | | | | | MG1 fixed | |
| | Mode 3 | X | | X | X | | MG1 drives drive | MG2 drives drive |
| | | | | | | | output; rotational | output; rotational |
| | | | | | | | speed MG2 variable | speed MG2 variable |
| | Mode 4 | X | X | | | | MG1 drives drive | MG2 drives drive |
| | | | | | | | output; rotational | output; rotational |
| | | | | | | | speed MG2 variable | speed MG2 variable |
| | Mode 5 | X | | X | | | MG1 drives drive | MG2 drives drive |
| | | | | | | | output; rotational | output; rotational |
| | | | | | | | speed MG1 variable | speed MG2 variable |
| | Mode 6 | X | | X | X | X | MG1 drives drive | MG2 drives drive |
| | | | | | | | output and/or first | output and/or first |
| | | | | | | | power output; | power output; |
| | | | | | | | rotational speed | rotational speed |
| | | | | | | | MG1 fixed | MG2 variable |
| | Mode 7 | X | X | | | X | MG1 drives drive | MG2 drives drive |
| | | | | | | | output and/or first | output and/or first |
| | | | | | | | power output; | power output; |
| | | | | | | | rotational speed | rotational speed |
| | | | | | | | MG1 fixed | MG2 variable |
| | Mode 8 | X | | X | | X | MG1 drives drive | MG2 drives drive |
| | | | | | | | output and/or first | output and/or first |
| | | | | | | | power output; | power output; |
| | | | | | | | rotational speed | rotational speed |
| | | | | | | | MG1 fixed | MG2 variable |

The modes can be obtained by opening and closing the shift elements or coupling elements associated with the reference signs indicated and operating the energy machines as illustrated in Table 2. The modes can be obtained by opening and closing the first shift element (reference sign 210) and/or the second shift element (reference sign 324) and/or third shift element (reference sign 326) and/or the fourth shift element (reference sign 602) and/or fifth shift element (reference sign 220) and operating the first and second energy machines (reference signs 50, 56 or MG1 and MG2) as illustrated in Table 2.

In the third embodiment, 10 modes per direction of rotation of the drive output of the drive apparatus, or in other words in the forward and reverse direction of the drive apparatus or work machine can be obtained by means of the first transmission unit and by means of the second transmission unit, comprising the third planetary gear and the first cylindrical gear stage and the second and third and fourth shift elements, and optionally the fifth and/or a sixth shift element (see below for details) (see Table 3). More specifically, 10 forward and 10 reverse gears of the drive apparatus 20 or work machine 10 can be obtained.

TABLE 3
Modes of the third embodiment with the fifth and sixth shift elements.

| | | | | | | | | 50 | 56 |
|---|---|---|---|---|---|---|---|---|---|
| Forward | Reverse | 210 | 324 | 326 | 234 | 602 | 220 | (MG1 below) | (MG2 below) |
| Mode 1 | | | | | X | | | — | MG2 drives |
| | | | | | | | | | countershaft |
| | | | | | | | | | and/or drive |
| | | | | | | | | | output; |
| | | | | | | | | | rotational speed |
| | | | | | | | | | MG2 variable |
| Mode 2 | | | X | X | | | | — | MG2 drives |
| | | | | | | | | | countershaft |
| | | | | | | | | | and/or drive |
| | | | | | | | | | output; |
| | | | | | | | | | rotational speed |
| | | | | | | | | | MG2 variable |
| Mode 3 | | | | | X | | X | MG1 drives | MG2 drives |
| | | | | | | | | first power | countershaft |
| | | | | | | | | output; | and/or drive |
| | | | | | | | | rotational speed | output; |
| | | | | | | | | MG1 fixed | rotational speed |
| | | | | | | | | | MG2 variable |
| Mode 4 | | | X | X | | | X | MG1 drives | MG2 drives |
| | | | | | | | | first power | countershaft |
| | | | | | | | | output; | and/or drive |
| | | | | | | | | rotational speed | output; |
| | | | | | | | | MG1 fixed | rotational speed |
| | | | | | | | | | MG2 variable |
| Mode 5 | | X | | X | | X | | MG1 drives | MG2 drives |
| | | | | | | | | countershaft | countershaft |
| | | | | | | | | and/or drive | and/or drive |
| | | | | | | | | output; | output; |
| | | | | | | | | rotational speed | rotational speed |
| | | | | | | | | MG2 variable | MG2 variable |
| Mode 6 | | X | X | | | | | MG1 drives | MG2 drives |
| | | | | | | | | countershaft | countershaft |
| | | | | | | | | and/or drive | and/or drive |
| | | | | | | | | output; | output; |
| | | | | | | | | rotational speed | rotational speed |
| | | | | | | | | MG2 variable | MG2 variable |
| Mode 7 | | X | | X | | | | MG1 drives | MG2 drives |
| | | | | | | | | countershaft | countershaft |
| | | | | | | | | and/or drive | and/or drive |
| | | | | | | | | output; | output; |
| | | | | | | | | rotational speed | rotational speed |
| | | | | | | | | MG2 variable | MG2 variable |
| Mode 8 | | X | | X | | X | X | MG1 drives | MG2 drives |
| | | | | | | | | drive output | drive output |
| | | | | | | | | and/or | and/or |
| | | | | | | | | countershaft | countershaft |
| | | | | | | | | and/or first | and/or first |
| | | | | | | | | power output; | power output; |
| | | | | | | | | rotational speed | rotational speed |
| | | | | | | | | MG1 fixed | MG2 variable |
| Mode 9 | | X | X | | | | X | MG1 drives | MG2 drives |
| | | | | | | | | drive output | drive output |
| | | | | | | | | and/or | and/or |
| | | | | | | | | countershaft | countershaft |
| | | | | | | | | and/or first | and/or first |
| | | | | | | | | power output; | power output; |
| | | | | | | | | rotational speed | rotational speed |
| | | | | | | | | MG1 fixed | MG2 variable |
| Mode 10 | | X | | X | | | X | MG1 drives | MG2 drives |
| | | | | | | | | drive output | drive output |
| | | | | | | | | and/or | and/or |
| | | | | | | | | countershaft | countershaft |
| | | | | | | | | and/or first | and/or first |
| | | | | | | | | power output; | power output; |
| | | | | | | | | rotational speed | rotational speed |
| | | | | | | | | MG1 fixed | MG2 variable |
| | Mode 1 | | | | X | | | — | MG2 drives |
| | | | | | | | | | countershaft |
| | | | | | | | | | and/or drive |
| | | | | | | | | | output; |
| | | | | | | | | | rotational speed |
| | | | | | | | | | MG2 variable |
| | Mode 2 | | X | X | | | | — | MG2 drives |
| | | | | | | | | | countershaft |
| | | | | | | | | | and/or drive |
| | | | | | | | | | output; |
| | | | | | | | | | rotational speed |
| | | | | | | | | | MG2 variable |
| | Mode 3 | | | | X | | X | MG1 drives | MG2 drives |
| | | | | | | | | first power | countershaft |
| | | | | | | | | output; | and/or drive |
| | | | | | | | | rotational speed | output; |
| | | | | | | | | MG1 fixed | rotational speed |
| | | | | | | | | | MG2 variable |
| | Mode 4 | | X | X | | | X | MG1 drives | MG2 drives |
| | | | | | | | | first power | countershaft |
| | | | | | | | | output; | and/or drive |
| | | | | | | | | rotational speed | output; |
| | | | | | | | | MG1 fixed | rotational speed |
| | | | | | | | | | MG2 variable |
| | Mode 5 | X | | X | | X | | MG1 drives | MG2 drives |
| | | | | | | | | countershaft | countershaft |
| | | | | | | | | and/or drive | and/or drive |
| | | | | | | | | output; | output; |
| | | | | | | | | rotational speed | rotational speed |
| | | | | | | | | MG2 variable | MG2 variable |
| | Mode 6 | X | X | | | | | MG1 drives | MG2 drives |
| | | | | | | | | countershaft | countershaft |
| | | | | | | | | and/or drive | and/or drive |
| | | | | | | | | output; | output; |
| | | | | | | | | rotational speed | rotational speed |
| | | | | | | | | MG2 variable | MG2 variable |
| | Mode 7 | X | | X | | | | MG1 drives | MG2 drives |
| | | | | | | | | countershaft | countershaft |
| | | | | | | | | and/or drive | and/or drive |
| | | | | | | | | output; | output; |
| | | | | | | | | rotational speed | rotational speed |
| | | | | | | | | MG2 variable | MG2 variable |
| | Mode 8 | X | | X | | X | X | MG1 drives | MG2 drives |
| | | | | | | | | drive output | drive output |
| | | | | | | | | and/or | and/or |
| | | | | | | | | countershaft | countershaft |
| | | | | | | | | and/or first | and/or first |
| | | | | | | | | power output; | power output; |
| | | | | | | | | rotational speed | rotational speed |
| | | | | | | | | MG1 fixed | MG2 variable |
| | Mode 9 | X | X | | | | X | MG1 drives | MG2 drives |
| | | | | | | | | drive output | drive output |
| | | | | | | | | and/or | and/or |
| | | | | | | | | countershaft | countershaft |
| | | | | | | | | and/or first | and/or first |
| | | | | | | | | power output; | power output; |
| | | | | | | | | rotational speed | rotational speed |
| | | | | | | | | MG1 fixed | MG2 variable |
| | Mode 10 | X | | X | | | X | MG1 drives | MG2 drives |
| | | | | | | | | drive output | drive output |
| | | | | | | | | and/or | and/or |
| | | | | | | | | countershaft | countershaft |
| | | | | | | | | and/or first | and/or first |
| | | | | | | | | power output; | power output; |
| | | | | | | | | rotational speed | rotational speed |
| | | | | | | | | MG1 fixed | MG2 variable |

The modes can be obtained by opening and closing the shift elements or coupling elements associated with the reference signs indicated and operating the energy machines as illustrated in Table 3. The modes can be obtained by opening and closing the first shift element and/or the second shift element (324) and/or third shift element (326) and/or the fourth shift element (602) and/or fifth shift element (220) and/or sixth shift element (234) and operating the first and second energy machines (reference signs 50, 56 or MG1 and MG2) as illustrated in Table 3.

It is thereby advantageously possible to provide a drive apparatus, for example an electric drive apparatus, particularly for example a purely electric drive apparatus, by means of which, when the first shift element is open, the first energy machine can drive the first power output independently of the second energy machine, and the second energy machine can drive the drive output via the first and/or second transmission unit or the countershaft independently of the first energy machine. Moreover, the drive apparatus additionally has two mutually independent transmissions, which can be power-shifted by means of the second, third and fourth shift elements, thereby enabling the second energy machine to be made more compact. In addition, it is possible, when the first shift element is closed, to output the powers of both energy machines to the first and/or second transmission unit. It is likewise advantageously possible, by means of the second transmission unit, to use at least one further infinitely variable mode, for example with a synchronously selectable changeover point, thereby enabling both energy machines to be made more compact. In addition, it is possible, when the first shift element is closed, for power to be transmitted to the first power output with a constant rotational speed of the first energy machine and, at the same time, by changing the rotational speed at the second energy machine, for a rotational speed that is infinitely variable, starting from zero, to be set at the first and/or second transmission unit or the countershaft, while simultaneously transmitting power to the drive apparatus, for example the first and/or second transmission unit or the countershaft. In this case, at least one further infinitely variable mode, for example with a synchronous changeover point, can be used by the second transmission unit. A more efficient and more compact drivetrain can thereby advantageously be made possible.

As a refinement of the disclosure, the second transmission unit is arranged downstream of the first transmission unit in the power flow and/or force flow and/or torque flow.

As a refinement of the disclosure, the drive apparatus comprises power electronics. By means of the power electronics, power, for example electric power, can be transmissible between the first and/or second energy machine, for example a first and/or second electric motor, and/or an energy store. The drive apparatus or the axle or the work machine can comprise the power electronics and/or the energy store or stores. The power electronics can be integrated into the control unit or be operable as an external unit or as external units by the control unit. The power electronics can comprise an electronic control device and/or an inverter and/or a voltage transformer. During operation, the inverter and/or the voltage transformer can transform the voltage of the energy store into a voltage or energy or power that is required by the first and/or second energy machine. This process can be reversed for the purposes of charging the energy store. The energy store can be operable by the electronic control device in order to store electric energy and/or power and/or to output same to the first and/or second energy machine, for example the first and/or second electric motor. The control unit or the electronic control device and/or the first and/or second energy machine, for example the first and/or second electric motor, can be electrically connected and/or electrically couplable or coupled to the power electronics and/or the energy store. The power electronics, for example the electronic control device, can be integrated into the control unit. The first and/or second energy machine can be designed as a generator and can charge the energy store, for example in a regeneration mode. The energy store or stores can be electrically connected and/or electrically couplable to the first and/or second energy machine, for example the first and/or second electric motor. The energy store can be an electric energy store. The energy store can supply the first and/or second energy machine, for example the first and/or second electric motor, with energy, for example electric energy. The energy store can be connected and/or couplable, for example electrically connected and/or electrically couplable, to the first and/or second energy machine, for example the first and/or second electric motor. The energy store can be designed as a battery and/or a rechargeable battery and/or a supercapacitor and/or a fuel cell and/or some other device for storing electric energy. This advantageously enables the abovementioned advantages to be achieved.

As a refinement of the disclosure, the first and/or second transmission unit have/has a passage or a plurality of passages, for example one or more central passages, for the drive input, for example the input shaft. The drive input, for example the input shaft, can additionally be designed, for example also usable, as a power take-off drive shaft (PTO drive shaft). The drive input, for example the input shaft, and the power take-off drive shaft can be designed as a shaft, for example a common shaft. The drive input, for example the input shaft, can be embodied as a solid shaft. The passage or the passages, for example the central passage or passages, can be designed as one or more shaft leadthroughs, for example one or more central shaft leadthroughs, for the drive input, for example the input shaft. The first and/or second transmission unit can thus have one or more shaft leadthroughs, for example one or more central leadthroughs, for the drive input, for example the input shaft. The sun of the planetary coupling gear and/or the first and second sun of the first and second planetary gear and/or the sun of the third planetary gear and/or the first and/or second and/or third cylindrical gear stage can each have passages, for example shaft leadthroughs, for the drive input, for example the input shaft. In this way, direct and thus particularly energy-efficient transmission of the torque and/or force and/or rotational speed to the first power output of the drive apparatus or work machine is possible.

As a refinement of the disclosure, the first energy machine is connectable or connected to a first power output, for example to the first power output by means of the fifth or by the fifth shift element. The first power output can comprise a power take-off unit or be designed as a power take-off unit. The power take-off unit can comprise a power take-off gear and/or a power take-off shaft. The first energy machine can be connected to the fifth shift element via the drive input, for example the input shaft. The fifth shift element can be connected to the first power output, for example to the power take-off gear and/or the power take-off shaft. The fifth shift element can connect the drive input, for example the input shaft, to the first power output, for example the power take-off gear and/or the power take-off shaft. The first power output, for example the power take-off unit, particularly for example the power take-off gear, can thus be connectable or connected to the drive input, for example the input shaft, and/or the power take-off drive shaft on the driving side, for example via or by the fifth shift element. Moreover, the first power output, for example the power take-off unit, particularly for example the power take-off gear, can be connectable or connected on the driven side to the power take-off shaft. The first power output can be drivable by means of the first energy machine. One significant advantage of this disclosure is that, when the first shift element is open, the first energy machine can drive the first power output independently of the second energy machine. In addition, at the same time, the second energy machine can drive the drive apparatus, for example the first and/or second transmission unit, independently of the first energy machine. In addition, it is possible, when the first shift element is closed, for power to be transmitted to the first power output and/or the first and/or second transmission unit with a constant rotational speed of the first energy machine and, at the same time, by changing the rotational speed at the second energy machine, for a rotational speed at the drive apparatus, for example of the first and/or second transmission unit, that is infinitely variable, starting from zero, to be set and/or adjusted. In this case, power transmission to the drive apparatus, for example the first and/or second transmission unit can take place at the same time. A more efficient and more compact drivetrain can thereby advantageously be made possible. Moreover, it is thereby advantageously possible to achieve a modular and/or structurally simple configuration of the drive apparatus, for example of the first power output.

As a refinement of the disclosure, the drive output and/or the first transmission unit is connectable or connected to a countershaft. The first transmission unit, for example the second input and/or the first sun of the first planetary transmission can be connectable or connected to the countershaft directly or via a or by means of a or by a third transmission stage, e.g. one or more fifth cylindrical gear stages or a third gearwheel pair or three or more gearwheels or a sixth planetary gear or some other gear. Alternatively or in addition, however, it is also possible for the second energy machine to be connectable or connected to the countershaft directly or via a or by means of a or by a fourth transmission stage, e.g. one or more sixth cylindrical gear stages and/or a fourth gearwheel pair and/or three or more gearwheels and/or a seventh planetary gear and/or some other gear, and/or the second transmission stage. Alternatively, however, it is also possible for the second energy machine to be connectable or connected to the countershaft via the first transmission unit, for example the second input and/or the first sun of the first planetary gear, via the or by means of the or by the third transmission stage. The drive apparatus can comprise the sixth shift element. The second energy machine and/or the first transmission unit can be connectable or connected to the countershaft via or by the sixth shift element. The sixth shift element can be arranged on or at the countershaft, for example can be connectable to the countershaft. The drive output can be connectable or connected to the countershaft via a or by means of a or by a fifth transmission stage, e.g., a seventh cylindrical gear stage or a fifth gearwheel pair or three or more gearwheels or an eighth planetary gear or some other gear. Moreover, the countershaft can be connected to the travel drive, for example the front axle drive. The countershaft can be connectable or connected to a further shaft by means of a further transmission stage, e.g., a further cylindrical gear stage or a gearwheel pair or three or more gearwheels or a further planetary gear or some other gear, and/or a further shift element. The countershaft or the further shaft can be connected to the first differential or the front axle differential. The countershaft can be a solid shaft. The countershaft and/or the drive input, for example the input shaft, and/or the drive output, for example the output shaft, can be arranged coaxially with one another. It is thereby advantageously possible to implement an additional starting gear by way of the sixth shift element.

As a refinement of the disclosure, the drive apparatus comprises a control unit. The control unit is described in detail above and below.

The disclosure furthermore relates to an axle, for example an electrically driven axle, for a work machine, comprising a drive apparatus, for example a drive apparatus in one or more embodiments disclosed herein. The drive apparatus can be arranged on the axle or integrated into the axle.

The disclosure also relates to a gear housing assembly having a drive apparatus, for example a drive apparatus in one or more embodiments disclosed herein. The gear housing assembly comprises a first housing module with the first transmission unit, wherein the first housing module has an input-side housing wall and an output-side housing wall. The input-side and output-side housing walls of the first housing module can be any housing wall of the first housing module. The input-side housing wall of the first housing module has at least one first input opening, for example a first and second input opening. The first input opening, for example the first and second input openings, can be designed for the attachment and/or connection of the inputs of the first transmission unit. The output-side housing wall of the first housing module has at least one first output opening, for example a first and second output opening. The first output opening can be designed for the attachment and/or connection of the first output, for example also of the second output, of the first transmission unit to the third input, for example also of the fourth input, of the second transmission unit. The second output opening can be designed for the attachment and/or connection of the second output of the first transmission unit to the fourth input of the second transmission unit. The work machine can comprise the gear housing assembly.

The first and second inputs can be arranged in the first input opening of the input-side housing wall of the first housing module. More specifically, the first and second inputs, for example the first and second driving elements, can extend through the first input opening. However, it is also possible for the first input to be arranged in the first input opening and for the second input to be arranged in the second input opening. More specifically, the first input, for example the first driving element, can extend through the first input opening, and the second input, for example the second driving element, can extend through the second input opening.

The first and second outputs can be arranged in the first output opening of the output-side housing wall of the first housing module. More specifically, the first and second outputs, for example the first and second driven elements, can extend through the first output opening. However, it is also possible for the first output to be arranged in the first output opening and for the second output to be arranged in the second output opening. More specifically, the first output, for example the first driven element, can extend through the first output opening, and the second output, for example the second driven element, can extend through the second output opening.

More specifically, the first transmission unit can be arranged in the first housing module. Moreover, it is possible for the first and/or second energy machine and/or the second and/or fourth transmission stage and/or at least part of the countershaft and/or at least part of the drive output to be arranged in the first housing module. The countershaft can be arranged in the first input opening or a third input opening of the input-side housing wall of the first housing module and/or the first output opening or a third output opening of the output-side housing wall of the first housing module. More specifically, the countershaft can extend through the first or third input opening and/or the first or third output opening. The first housing module can have internal bearing locations, e.g., in the form of webs or other bearing and/or fastening devices. The first transmission unit, for example components of the first transmission unit, can be supportable at and/or on and/or in the bearing locations. In addition, it is possible for the first and/or second energy machine and/or the second and/or fourth transmission stage and/or at least part of the countershaft and/or at least part of the drive output to be supportable at and/or on and/or in the bearing locations.

The input-side or a further input-side and the output-side or a further output-side housing wall of the first housing module can have a first and second through opening, for example central first and second through openings, for the drive input, for example the input shaft.

However, the input-side and output-side housing walls of the first housing module can also be designed as a common housing wall of the first housing module, for example a first common housing wall. The common housing wall of the first housing module can comprise at least the first input opening, for example the first and second and/or third input openings, and at least the first output opening, for example the first and second and/or third output openings, and for example a common through opening. It is essential that the inputs or the driving elements thereof extend through the input openings of the first housing module and that the drive output extends through the output opening. This advantageously enables the housing assembly to be attachable in a simple manner and/or to be of modular construction.

The gear housing assembly can have a second housing module with the second transmission unit. The second housing module can have an input-side housing wall and an output-side housing wall. The input-side housing wall of the second housing module has at least one further input opening, for example a fourth input opening or a fourth and fifth input opening. The fourth input opening can be designed for the attachment and/or connection of the third and/or fourth input of the second transmission unit to the first and/or second output of the first transmission unit. The fifth input opening can be designed for the attachment and/or connection of the fourth input of the second transmission unit to the second output of the first transmission unit. The third and/or fourth input and/or the first and/or second output can be arranged in the fourth input opening of the input-side housing wall of the second housing module. More specifically, the third and/or fourth input, for example the third and/or fourth driving element or the first and/or second driven element, and/or the first and/or second output, for example the first and/or second driven element, can extend through the fourth input opening.

The fourth input and/or the second output can be arranged in the fifth input opening of the input-side housing wall of the second housing module. More specifically, the fourth input, for example the fourth driving element or the second driven element, and/or the second output, for example the second driven element, can extend through the fifth input opening.

The output-side housing wall of the second housing module can have a further output opening, for example a third output opening. The drive output, for example the output shaft, can be arranged in the third output opening of the output-side housing wall of the second housing module. More specifically, the drive output, for example the output shaft, can extend through the third output opening.

More specifically, the second transmission unit and the drive output can be arranged in the second housing module. Moreover, it is possible for the first and/or second energy machine and/or the first and/or second transmission stage and/or at least part of the countershaft to be arranged in the second housing module. The countershaft can be arranged in a sixth input opening of the input-side housing wall of the second housing module. More specifically, the countershaft can extend through the sixth input opening. The second housing module can have internal bearing locations, e.g., in the form of webs or other bearing and/or fastening devices. The second transmission unit, for example components of the second transmission unit, and the drive output, can be supportable at and/or on and/or in the bearing locations. In addition, it is possible for the first and/or second energy machine and/or the first and/or second transmission stage and/or at least part of the countershaft to be supportable at and/or on and/or in the bearing locations. For example, here too, the low assembly effort and high degree of compatibility and variability in comparison with conventional gear housing assemblies is clear.

The input-side or a further input-side housing wall of the second housing module can have a third through opening, for example a central third through opening, for the drive input, for example the input shaft. The output-side or a further output-side housing wall of the second housing module can have a fourth through opening, for example a central fourth through opening, for the drive input, for example the input shaft. However, the input-side and output-side housing walls of the second housing module can also be designed as a common housing wall of the second housing module, for example a second common housing wall. The common housing wall of the second housing module can comprise at least the fourth input opening, for example the fourth and fifth input openings, and the second output opening, and for example a further common through opening. In this way, direct and thus particularly energy-efficient transmission of the torque and/or force and/or rotational speed to a first power output of the drive apparatus or axle or work machine is possible.

It is likewise possible for the output-side housing wall of the first housing module and the input-side housing wall of the second housing module to be designed as a common housing wall of the first and second housing modules. The common housing wall of the first and second housing modules can comprise, as common openings, the third and/or fourth input opening and the second and third through openings as a common through opening, for example a common central through opening.

The first housing module can be connectable to the second housing module, for example the input-side housing wall of the second housing module and the output-side housing wall of the first housing module can be connectable or are connected to one another. The first and second housing modules can be connected to one another, for example fastened to one another, particularly for example releasably fastened to one another, by means of or by one or more fastening surfaces and housing flanges. In this case, the first housing module can comprise one or more fastening surfaces, and the second housing module can comprise one or more housing flanges. It is likewise possible, conversely, for the first housing module to comprise one or more housing flanges, and for the second housing module to comprise one or more fastening surfaces. Alternatively, the first and second housing modules can comprise a plurality of housing flanges and a plurality of fastening surfaces.

The input openings and/or output openings and/or through openings can be, for example, openings or holes or passages for the inputs and outputs of the first and second transmission units and the drive output and, for example, the drive input and/or the countershaft. More specifically, the input openings and/or output openings and/or through openings can each be designed as shaft leadthroughs, for example central shaft leadthroughs. This enables the first and second transmission units, for example, to be connectable to one another via the input openings and/or output openings. Further connection possibilities for further housing modules can be provided on the housing wall of the first and/or second housing module in order, for example, to enable the first and/or second differential or the first power output to be connected to the drive input and/or drive output extending through the output-side housing wall of the first housing module. The first and second housing modules can be arranged along a longitudinal axis of the gear housing assembly and, for example, a longitudinal axis of the work machine. The longitudinal axis of the gear housing assembly and the longitudinal axis of the work machine can be identical or parallel.

The gear housing assembly can thus advantageously be of modular construction. In this context, “modular” is intended to mean that the gear housing assembly is composed of a plurality of housing modules and that, for each of the transmission units described above, a housing module is formed which, in combination with the other housing modules, forms the entire gear housing assembly. Here, the adjacent and/or adjoining housing walls can be designed as common housing walls. Such an arrangement makes it possible to carry out an exchange of the first and/or second transmission unit easily and economically without having to completely disassemble the entire drive apparatus. Here, the advantages of a gear assembly in respect of lower assembly effort and a high degree of compatibility and variability become clear. Moreover, the gear housing assembly advantageously enables the drive apparatus to be arranged in modular fashion and/or constructed in a modular way.

The disclosure further relates to a work machine having an axle, for example an axle in one or more embodiments disclosed herein, or to a drive apparatus, for example a drive apparatus in one or more embodiments disclosed herein, or to a gear housing assembly, for example a gear housing assembly in one or more embodiments disclosed herein. The work machine can be a construction machine or a towing vehicle, for example an agricultural towing vehicle, for example a tractor. The work machine has the above-described advantages of the drive apparatus and/or gear housing assembly.

The work machine comprises the drive apparatus and/or the axle and/or gear housing assembly. The drive apparatus is designed for driving the work machine. The work machine can comprise one, two or more axle(s). More specifically, the drive apparatus can be integrated onto or into the axle, for example into the first and/or second vehicle axle. The work machine can be drivable with a rotational speed and/or force and/or a torque of the first and/or second variator and/or motor.

The control unit can be configured for exercising open-loop and/or closed-loop control over, for example for setting and/or adjusting, the work machine, for example the motor and/or the first and/or second variator. The work machine can comprise an input and output unit. The control unit can be connected to the input and output unit by signals, and/or operatively coupled and/or connected thereto for transmitting signals and/or carrying data, and/or can be operable and/or settable and/or adjustable by means of the input and output unit. The input and output unit can be integrated into the control unit, or vice versa. The operator of the work machine can use the input and output unit to set and/or adjust a speed of the work machine, for example.

The work machine can moreover comprise one or more auxiliary units, for example a pump and/or a radiator, etc. The auxiliary units can be part of the hydraulic system of the drive apparatus. The work machine can comprise the first power output, for example the power take-off unit, instead of the drive apparatus. The control unit can be configured to set and/or adjust and/or control the drive apparatus and/or the axle and/or work machine by means of a driving signal and to set and/or adjust, for example to increase or reduce, a speed of the work machine by means of and/or based on the driving signal. The work machine can comprise the one or more ground-engaging means. The ground-engaging means can support and/or carry the work machine on the ground. A towing vehicle frame of the work machine, for example a first and second frame element, can be supported on the ground-engaging means. The ground-engaging means can be wheels or tracks or chains. For example, the ground-engaging means can be front wheels and rear wheels. The work machine can comprise a speed sensor, for example a rotational speed sensor, for detecting a speed of the work machine. More specifically, the control unit can be configured to set and/or adjust and/or control a force and/or a torque and/or a rotational speed of the motor and/or of the first and/or second variator by means of the driving signal.

As a refinement of the disclosure, the work machine comprises two frame elements, for example a first and a second frame element. The drive apparatus, for example the gear housing assembly, particularly for example the first and/or second housing module, is arranged on, for example between, the frame elements. The frame elements, for example the first and second frame elements, can be arranged parallel to the longitudinal axis of the work machine. The gear housing assembly, for example the first and second housing modules, can be arranged along the longitudinal axis of the work machine. The longitudinal axis of the gear housing assembly and the longitudinal axis of the work machine can be identical or parallel. The first and/or second housing module can be arranged between the frame elements, for example also secured and/or mounted thereon. The power take-off unit can likewise be arranged on the frame elements, for example secured and/or mounted thereon.

The shift elements, for example the valves or valve devices or actuators thereof, and/or the energy store and/or the power electronics and/or the first and/or second variator and/or the motor and/or the first power output, for example the power take-off unit, can be operable and/or settable and/or adjustable, for example under open-loop and/or closed-loop control, by means of the control unit. The control unit can send and/or receive signals to control the operation of the drive apparatus and/or of the axle and/or of the work machine. The signals can be expediently provided via a suitable data communication network, for example one which conforms to the ISOBUS and/or CAN standard. The control unit can be designed as an electronic module, an embedded system, a computing unit, a computer, as a module for open-loop and/or closed-loop control of the drive apparatus and/or of the axle and/or of the work machine. The control unit can comprise one or more processors, a memory and/or all of the software, hardware, algorithms, connections, and for example also sensors, which are required for the open-loop and/or closed-loop control of the drive apparatus and/or of the axle and/or of the work machine. Methods can take the form of a program or algorithm which can be executed on and/or by means of the control unit. The control unit can comprise any device which analyzes data from various sensors, compares data and makes the necessary decisions to exercise open-loop and/or closed-loop control over and/or carry out the operation of the drive apparatus and/or of the axle and/or of the work machine and the necessary tasks for open-loop and/or closed-loop control of the operation of the drive apparatus and/or of the axle and/or of the work machine. The control unit can be connected by signals and/or operatively coupled and/or connected for transmitting signals and/or carrying data to the component parts of the drive apparatus and/or of the axle and/or of the work machine, that is to say, for example, the first power output and/or the shift elements, for example the valves or valve devices or actuators of the shift elements and/or of the energy stores and/or the power electronics and/or the first and/or second variator and/or the motor and/or the sensors, e.g. the speed sensor and/or the rotational speed and/or torque sensor(s). Connected by signals, and/or operatively coupled and/or connected for transmitting signals and/or carrying data, can be understood here as meaning, inter alia, that signals and/or data can be exchanged between the connected component parts and the control unit. Signals can, for example, be received and sent, and/or processed and/or manipulated, by the control unit. The connection between the control unit and the component parts or components of the drive apparatus and/or of the axle and/or of the work machine can be implemented by wire, i.e., for example using cables, and/or in a wireless manner, i.e., by radio, for example using Bluetooth or WLAN. Communication can take place, for example, by means of ISOBUS, CAN bus, or the like. The control unit can be connected directly to an input and output unit, for example the input and output unit which is situated in a cab of the work machine, by means of which data entered by an operator can be transmitted to the control unit, or data can be received from the control unit and output. The control unit can be integrated into the input and output unit, or vice versa.

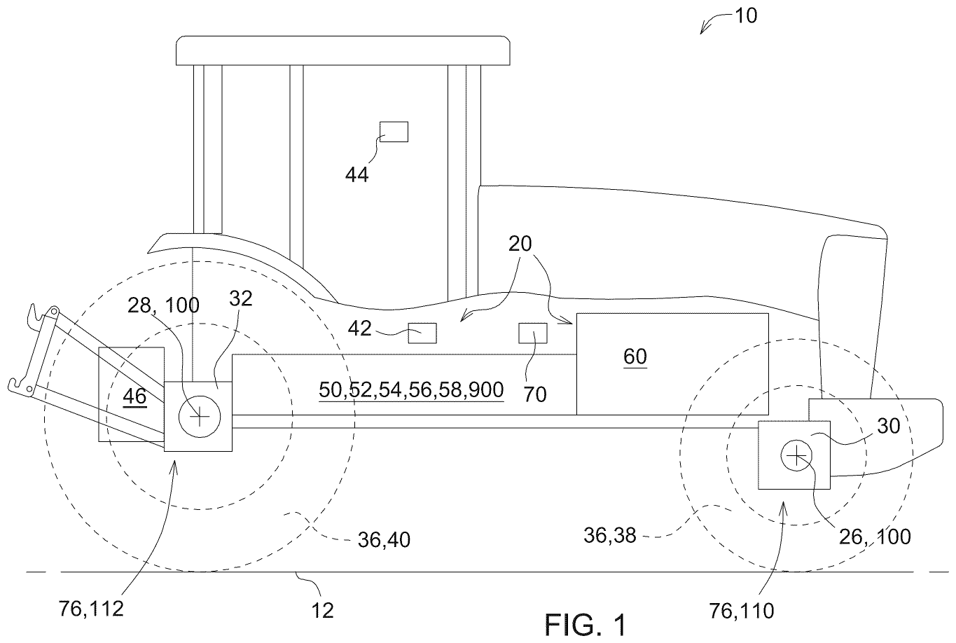

FIG. 1 shows a schematic illustration of a first example embodiment of a work machine 10 according to the disclosure, here of an agricultural towing vehicle or tractor, having a drive apparatus 20 according to the disclosure. The work machine 10 is drivable by means of the drive apparatus 20.

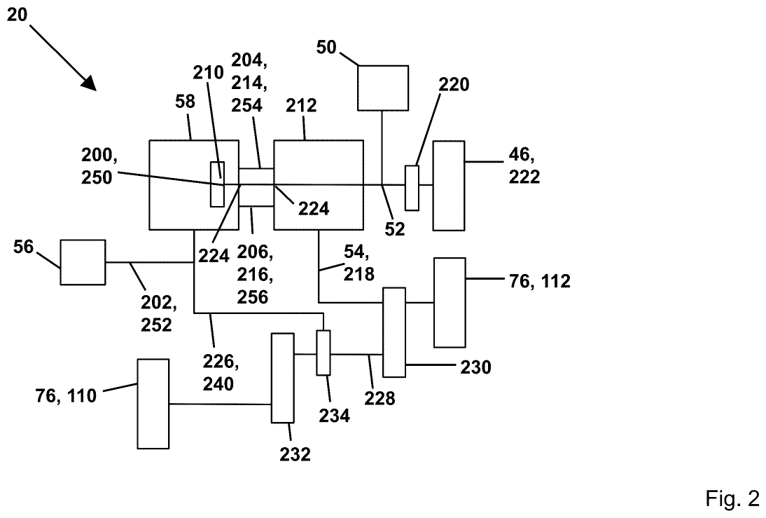

The drive apparatus 20 comprises a drive input 52, which can be designed, for example, as a drive shaft or input shaft, and a drive output 54, which can be designed, for example, as a driven shaft or output shaft, and a first and second energy machine 50, 56, and a first transmission unit 58. The first transmission unit 58 has a first and second input 200, 202 (see FIGS. 2 to 13) and a first and second output 204, 206 (see FIGS. 2 to 13). The drive input 52 is connectable or connected to the drive output 54 via the first transmission unit 58. In addition, the first energy machine 50 is connectable or connected to the first input 200 by a first or by means of a first shift element 210 (see FIGS. 2 to 7). The second energy machine 56 is connected to the second input 202.

The work machine 10, for example the drive apparatus 20, comprises a first vehicle axle 26 and a second vehicle axle 28. The first vehicle axle 26 can be a front axle, and the second vehicle axle 28 can be a rear axle. Moreover, the first vehicle axle 26 can be embodied as a steerable axle. The work machine 10, for example the drive apparatus 20, can comprise a travel drive 76, for example a front axle drive and a rear axle drive. The work machine 10 can have one or more ground-engaging means 36, in this case illustrated in the form of wheels 38, 40, which engage with an underlying surface 12 in order to transmit drive forces and/or by way of which the work machine 10 is supported on the underlying surface 12. The travel drive 76 can comprise the first vehicle axle 26 and/or the second vehicle axle 28 and/or a first differential 30 and/or a second differential 32 and/or the one or more ground-engaging means 36. The work machine 10, for example the drive apparatus 20, can have a front axle drive 110, which can comprise the first vehicle axle 26 and/or the first differential 30, that is to say, for example, a front axle differential, and/or the one or more ground-engaging means 36. Likewise, the work machine 10, or for example the drivetrain 20, can have a rear axle drive 112, which can comprise the second vehicle axle 28 and/or the second differential 32, that is to say, for example, a rear axle differential, and/or the one or more ground-engaging means 36. The first vehicle axle 26 can be connected to the first differential 30. The second vehicle axle 28 can be connected to the second differential 32.

The drive output 54 can be connected to the travel drive 76, for example the first and/or second differential 32, for example only to the second differential 32. The drive output 54 can be connected to the second vehicle axle via the second or by means of the second differential 32. Via the first or by means of the first differential 30 and/or the second or by means of the second differential 32, a force and/or a torque and/or a rotational speed can be transmissible from the drive output 54 to the first and/or second vehicle axle 26, 28 and thus, for example, to the ground-engaging means 36.

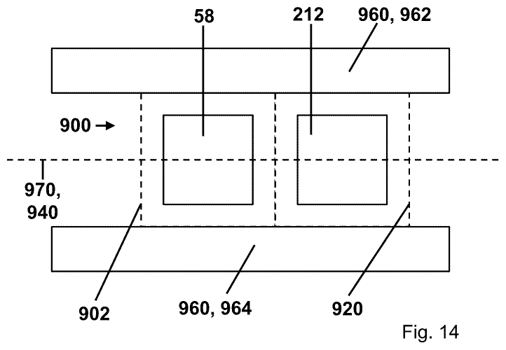

The first and second energy machines 50, 56 can be designed, for example, as a first and second electric motor. By means of the drive apparatus 20, for example the first and second energy machines 50, 56, a rotational movement and/or force and/or a torque and/or a rotational speed can be produced and can be transmissible, for example via the first and/or a second transmission unit 58, 212 and the drive output 54, to the first and/or second vehicle axle 26, 28. The first and/or second vehicle axle 26, 28 convert/s the rotational movement and/or force and/or the torque and/or the rotational speed into a rotational movement and/or force and/or torque and/or rotational speed of one or more ground-engaging means 36, and thus into propulsion of the work machine 10. The work machine 10 can furthermore have a towing vehicle frame, for example a first and second frame element 960, 962, 964 (see FIG. 14), wherein the chassis can be supported, for example, by the ground-engaging means 36, for example the wheels 38, 40, suspended from the first and/or second vehicle axle 28, 30. For example, a first pair of wheels 38 is arranged on the first vehicle axle 26, and a second pair of wheels 40 is arranged on the second vehicle axle 28. Here, the diameters of the wheels 38, 40 may differ; for example, the diameter of the first pair of wheels 38 may be smaller than the diameter of the second pair of wheels 40. Alternatively, the ground-engaging means 36 can also be configured and arranged as tracks or chains.

Alternatively, or in addition, the work machine 10 can furthermore comprise the drive apparatus 20 or an axle 100, power electronics 70 for transferring the electric power or energy between the first and second energy machines 50, 56, for example the first and the second electric motors, and an energy store 60. In the illustrated embodiment, the work machine 10 can be driven purely electrically or purely hydraulically. The work machine 10, for example the drive apparatus 20, can comprise a first power output 46. The first power output can comprise a power take-off unit 222. The first power output 46 can be provided for the purpose of driving an implement (not shown), which can be attached to the work machine 10 via an interface (e.g., three-point interface). More specifically, the axle 100 can comprise the drive apparatus 20, or the drive apparatus 20 can be arranged on or in said axle, e.g. on the first and/or second vehicle axle 26, 28. The energy store 60 can provide the electrically driven components of the drive apparatus 20, for example the first and second energy machines 50, 56, particularly for example the first and/or second electric motor, with currents or voltages of suitable frequency and amplitudes to provide desired output speeds or torques for the first power output 46 and/or the drive apparatus 20.

The work machine 10, but for example alternatively also the axle 100 or the drive apparatus 20, can comprise the control unit 42 and/or an input and output unit 44. The control unit 42 can be connected to the input and output unit 44 by signals, and/or operatively coupled thereto and/or connected thereto for transmitting signals and/or carrying data. More specifically, the control unit 42 can be connected directly to the input and output unit 44, which is situated in a cab of the work machine and by means of which data entered by an operator can be transmitted to the control unit 42, or data can be received from the control unit and output. The drive apparatus 20 and/or, for example, the work machine 10 or the axle 100 can be settable and/or adjustable by means of the control unit 42. The control unit 42 is connected to the first and second energy machines 50, 56 by signals, and/or operatively coupled thereto and/or connected thereto for transmitting signals and/or carrying data. The control unit 42 is configured to set and/or adjust the rotational speed and/or the torque and/or the force of the drive apparatus 20, for example of the first and second energy machines 50, 56, for example to operate them and/or subject them to open-loop and/or closed-loop control.

The control unit 42 can be configured to set and/or adjust a specifiable rotational speed and/or a specifiable torque and/or a specifiable force of the drive apparatus 20, for example of the first and second energy machines 50, 56, for example to operate them and/or subject them to open-loop and/or closed-loop control. The control unit 42 can be connected to the energy store 60 and/or to the power electronics 70 and/or sensors of the drive apparatus 20 by signals, and/or operatively coupled thereto and/or connected thereto for transmitting signals and/or carrying data. The control unit 42 can be configured to set and/or adjust the drive apparatus 20, for example alternatively or additionally the axle 100 or the work machine 10, in order to set and/or adjust, for example exercise open-loop and/or closed-loop control over, the rotational speed and/or the torque and/or the force of the first and second energy machines 50, 56.

It is essential for the disclosure that, by means of the first transmission unit, it is possible to obtain a drive apparatus in which the first energy machine can selectively drive the first power output independently of the second energy machine and, at the same time, the second energy machine can drive the drive apparatus, for example the first and/or second transmission unit, and/or the drive output and/or the countershaft and/or the travel drive, independently of the first energy machine, or, at the same time, the first and the second energy machine can drive exclusively the drive apparatus, for example the first and/or second transmission unit, and/or the drive output and/or the countershaft and/or the travel drive, or the first energy machine can transmit power to the first power output at a constant rotational speed while, at the same time, by rotational speed modification at the second energy machine, a rotational speed that is infinitely variable, starting from zero, can be set at the first and/or second transmission unit, and/or the drive output and/or the countershaft and/or the travel drive while power is simultaneously transmitted to these.

FIG. 2 shows a schematic illustration of a first example embodiment of the drive apparatus 20 according to the disclosure. The drive apparatus 20 shown in FIG. 2 corresponds substantially to the drive apparatus 20 shown in FIG. 1, and therefore only details and/or points of differentiation will be discussed below. The work machine 10 illustrated in FIG. 1 can comprise the drive apparatus 20 illustrated in FIG. 2.

The drive apparatus 20 according to FIG. 2 comprises the drive input 52 and the drive output 54 and the first and second energy machines 50, 56. In addition, the drive apparatus 20 comprises the first transmission unit 58, wherein the first transmission unit 58 has a first and second input 200, 202, for example a first and second driving element 250, 252, and a first and second output 204, 206, for example a first and second driven element 254, 256. The drive input 52 is connectable or connected to the drive output 54 via the first transmission unit 58 and, for example, selectively a second transmission unit 212 in addition. The first energy machine 50 is furthermore connectable or connected to the first input 200 by a first shift element 210, and the second energy machine 56 is connected to the second input 202.

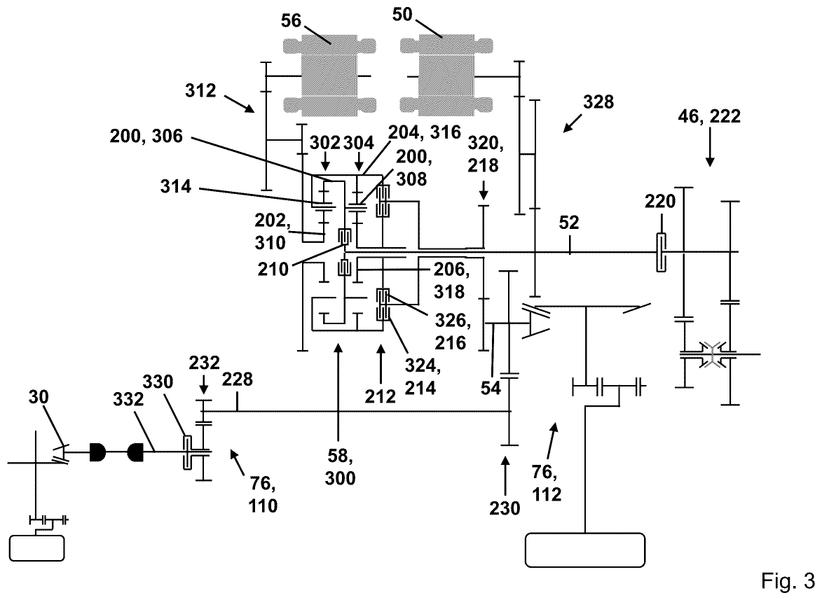

The first transmission unit 58 can be designed as a planetary coupling gear 300 (see FIG. 3), for example having two different stationary transmission ratios. Alternatively, or in addition, the first transmission unit 58 can comprise at least one first and/or second planetary gear 302, 304 (see FIGS. 3, 4 and 5), wherein the first and second planetary gears 302, 304 can be coupled to one another. More specifically, the first transmission unit 58 can comprise a first and second planetary gear 302, 304, wherein the first and second planetary gears 302, 304 can be coupled to one another. The first transmission unit 58 can thus have 4 degrees of freedom or, in other words, two inputs, the first and second inputs 200, 202, and two outputs, the first and second outputs 204, 206.

The first energy machine 50 can be designed as a first electric motor, and/or the second energy machine 56 can be designed as a second electric motor. The first and second energy machines 50, 56 can drive the drive apparatus 20 with a force and/or a rotational speed and/or a torque. The first energy machine 50 is connected on the driven side to the drive input 52, and the drive input 52 is connectable to the first transmission unit 58, for example the first input 200, for example the first driving element 250, via or by means of the first shift element 210. The second energy machine 56 is connected on the driven side to the second input 202, for example to the second driving element 252.

The drive apparatus 20 can also comprise a second transmission unit 212, which comprises a first cylindrical gear stage 320 and/or a second cylindrical gear stage 500 and/or a planetary gear, for example a third planetary gear 600, and at least one second and third shift element 324, 326. The second transmission unit 212 has two inputs, for example a third and fourth input 214, 216, and at least one third output 218. The first output 204 of the first transmission unit can be connected to the third input 214 of the second transmission unit 212, e.g., by means of a or by a shaft. As a result, a force and/or a torque and/or a rotational speed is transmissible from the first to the second transmission unit 58, 212. The second output 206 of the first transmission unit can be connected to the fourth input 216 of the second transmission unit 212, e.g., by means of a or by a shaft. As a result, a force and/or a torque and/or a rotational speed is transmissible from the first to the second transmission unit 58, 212. The second transmission unit 212 is arranged downstream of the first transmission unit 58 in the torque and/or power flow.

The drive apparatus 20 can furthermore comprise the first power output 46. The first energy machine 50 can be connectable or connected to the first power output 46, for example to the first power output 46 by means of the fifth or by the fifth shift element 220. The first power output 46 can comprise a power take-off unit 222. The power take-off unit 222 can comprise a power take-off gear and/or a power take-off shaft. The fifth shift element 220 and/or the power take-off unit 222, for example the power take-off gear, can be connected on the driving side to the drive input 52. Moreover, the power take-off unit 222, for example the power take-off gear, can be connectable or connected on the driven side to the power take-off shaft. The first and/or second transmission unit 58, 212 can furthermore have a passage 224, for example a central passage, for the drive input 52, that is to say, for example, the drive shaft or input shaft.

The drive output 54 and/or the first transmission unit 58 can be connectable or connected to a countershaft 228. The drive output 54 can be connected to the countershaft 228 via or by means of or by a fifth transmission stage 230, for example. The first transmission unit 58 and/or the second energy machine 56 can be connectable or connected to the countershaft 228, e.g., via or by means of or by a second and/or third and/or fourth transmission stage 312, 226, 240 and/or a sixth shift element 234. The drive output 54 can furthermore be connected to the travel drive 76, for example the second differential gear 32. The countershaft 228 can be connected to the travel drive 76, for example the first differential gear 30 via or by means of or by a sixth transmission stage 232, e.g., an eighth cylindrical gear stage or a sixth gearwheel pair or three or more gearwheels or a ninth planetary gear or some other gear. The countershaft 228 and/or the drive output 54, for example the output shaft, can be a solid shaft. The countershaft 228 and/or the drive output 54, for example the output shaft, can be arranged coaxially with one another.

FIG. 3 shows a schematic illustration of the second example embodiment of the drive apparatus 20 according to the disclosure. The drive apparatus 20 shown in FIG. 3 corresponds substantially to the drive apparatus 20 shown in FIGS. 1 and 2, and therefore only details and/or points of differentiation will be discussed below. The work machine 10 illustrated in FIG. 1 can comprise the drive apparatus 20 illustrated in FIG. 3.

The first transmission unit 58 comprises a planetary coupling gear 300 with two different stationary transmission ratios. The first transmission unit 58, for example the planetary coupling gear 300, comprises a first and second planetary gear 302, 304, wherein the planetary gears 302, 304 are coupled to one another.

The first annulus 306 of the first planetary gear 302 and the second planet carrier 308 of the second planetary gear 304 are designed as the first input 200 and/or are the first input 200. The first shift element 210 is connected to the first annulus 306 and the second planet carrier 308. The first energy machine 50 is connectable or connected to the drive input 52 via a or by means of a or by a first transmission stage 328, in the present case three gearwheels or two cylindrical gear stages, and the drive input 52 is connectable or connected to the first input 200 via the or by the first shift element 210. The first sun wheel 310 of the first planetary gear 302 is designed as the second input 202 and/or is the second input 202. The second energy machine 56 is connected to the second input 202, for example the first sun wheel 310, via a or by means of a by a second transmission stage 312, in the present case three gearwheels or two cylindrical gear stages. The first output 204 is connected to the first planet carrier 314 of the first planetary gear 302 and to the second annulus 316 of the second planetary gear 304. The second output 206 is connected to the second sun 318 of the second planetary gear 304.

The second transmission unit 212 comprises the first cylindrical gear stage 320, which is simultaneously designed as the third output 218, and the second and third shift elements 324, 326. The second shift element 324 is connected to the first output 204 of the first transmission unit 58, and the third shift element 326 is connected to the second output 206 of the first transmission unit 58. The first output 204 is connectable or connected to the first cylindrical gear stage 320 by the second shift element 324, and the second output 206 is connectable or connected to the first cylindrical gear stage 320 by the third shift element 326. Moreover, the second and/or third shift element 324, 326 is connectable or connected to the drive output 54 via the or by means of the first cylindrical gear stage 320.

The first energy machine 50 is connectable or connected to the first power output 46, for example the power take-off unit 222, for example via the first transmission stage 328. More specifically, the first energy machine 50 is connectable or connected to the first power output 46, for example by means of the fifth or by the fifth shift element 220. The drive output 54 is connected to the countershaft 228 via or by means of or by the fifth transmission stage 230, in the present case a seventh cylindrical gear stage. The drive input 52 and the drive output 54 are arranged coaxially and parallel to one another. The drive output 54 and the countershaft 228 are likewise arranged coaxially and parallel to one another. The countershaft 228 is connected to a further shaft 332 via or by means of or by the sixth transmission stage 232, in the present case an eighth cylindrical gear stage, and/or a seventh shift element 330. The further shaft 332 is connectable or connected to the first differential 30. By means of the drive apparatus 20 according to FIG. 3, it is advantageously possible to obtain the six modes per direction of rotation of the drive output or in the forward and reverse directions of the work machine according to Table 1 (see above).

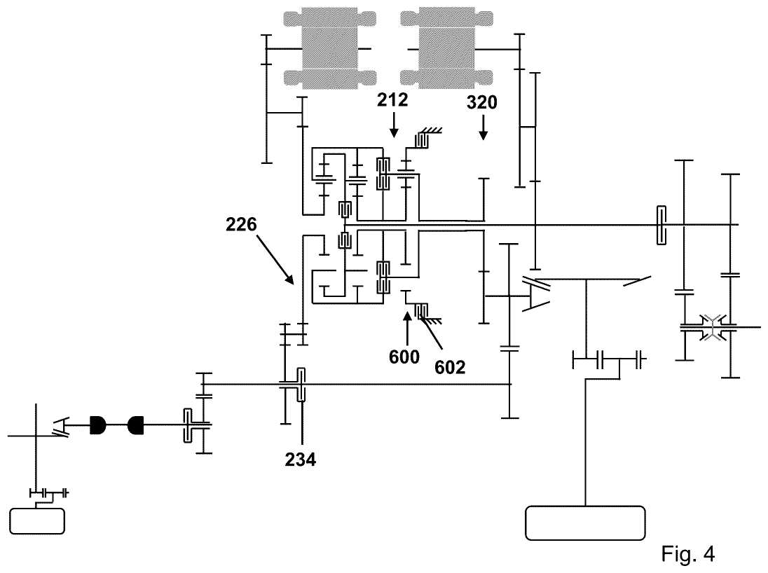

FIG. 4 shows a schematic illustration of the third example embodiment of the drive apparatus 20 according to the disclosure. The drive apparatus 20 shown in FIG. 4 corresponds substantially to the drive apparatus 20 shown in FIGS. 1 to 3, and therefore only details and/or points of differentiation will be discussed below. The work machine 10 illustrated in FIG. 1 can comprise the drive apparatus 20 illustrated in FIG. 4.

In addition to the drive apparatus 20 shown in FIG. 3, the second energy machine 56 is connectable or connected to the first transmission unit 58 and the fourth transmission stage 226, in the present case two sixth cylindrical gear stages, via or by the second transmission stage 312, and the sixth shift element 234 is connectable or connected to the countershaft 228. Moreover, the second transmission unit 212 comprises the first cylindrical gear stage 320 and the third planetary gear 600 and the second and the third and the fourth shift element 324, 326, 602. A detailed description of the second transmission unit 212 according to FIG. 4 or in this embodiment can be found in the description relating to FIG. 7. By means of the drive apparatus 20 according to FIG. 4, it is advantageously possible to obtain eight or ten modes for one direction of rotation of the drive output or in the forward driving direction of the work machine and eight or ten modes for the other direction of rotation of the drive output or in the reverse driving direction of the work machine according to Table 3.

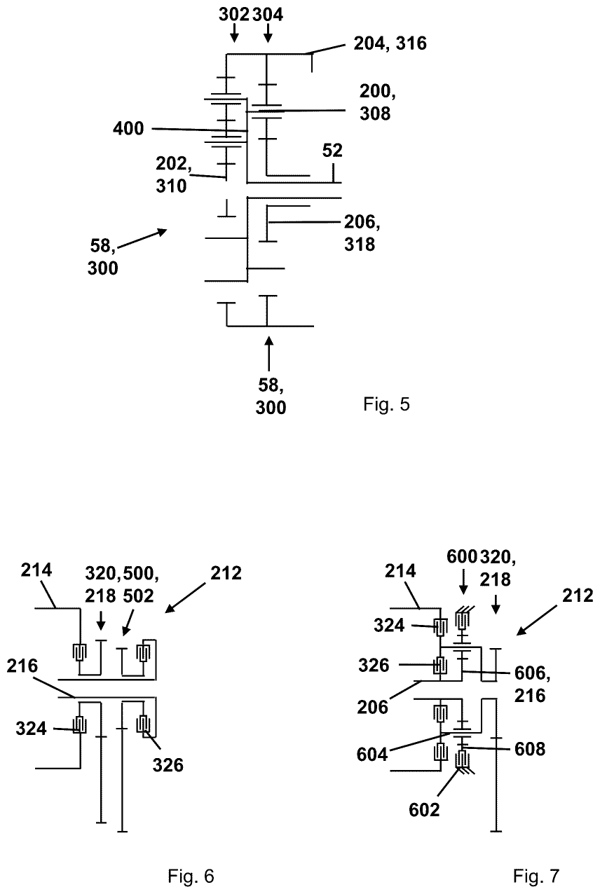

FIG. 5 shows a schematic illustration of a further example embodiment of the first transmission unit 58. The first transmission unit 58, which is shown in FIG. 5, corresponds substantially to the first transmission unit 58, shown in FIGS. 1 to 4, of the drive apparatus 20 according to the disclosure, and therefore only details and/or points of differentiation will be discussed below. The drive apparatus 20 or axle 100 or work machine 10 illustrated in FIGS. 1 to 4 can comprise the first transmission unit 58 illustrated in FIG. 5.

The first transmission unit 58, for example the planetary coupling gear 300, comprises a first and/or second planetary gear 302, 304, wherein the planetary gears 302, 304 are coupled to one another. The first planetary gear 302 comprises a double planet carrier 400. The first input 200 is the double planet carrier 400 of the first planetary gear 302 and the second planet carrier 308 of the second planetary gear 304. The first shift element 210 is connected to the double planet carrier 400 and the second planet carrier 308. The second input 202 is the first sun wheel 310 of the first planetary gear 302. The first output 204 is connected to the first annulus 306 of the first planetary gear 302 and to the second annulus 316 of the second planetary gear 304. The second output 206 is connected to the second sun 318 of the second planetary gear 304.

FIG. 6 shows a schematic illustration of a further example embodiment of the second transmission unit 212. The second transmission unit 212 shown in FIG. 6 corresponds substantially to the second transmission unit 212, shown in FIGS. 1 to 5, of the drive apparatus 20 according to the disclosure, and therefore only details and/or points of differentiation will be discussed below. The drive apparatus 20 or axle 100 or work machine 10 illustrated in FIGS. 1 to 4 can comprise the second transmission unit 212 illustrated in FIG. 6.

In the example embodiment according to FIG. 6, the second transmission unit 212 comprises the first and second cylindrical gear stages 320, 500 and the second and third shift elements 324, 326. Here, the first output 204 is connectable to the first cylindrical gear stage 320 by the or via the second shift element 324, and the second output 206 is connectable to the second cylindrical gear stage 500 by the third shift element 326. Moreover, the second shift element 324 is connectable or connected to the drive output 54 via the or by means of the first cylindrical gear stage 320. Moreover, the second transmission unit 212 has the third and fourth inputs 214, 216 and the third and fourth outputs 218, 502. The first cylindrical gear stage 320 is simultaneously designed as the third output 218, and the second cylindrical gear stage 500 is simultaneously designed as the fourth output 502. The third and fourth outputs 218, 502 are connected to the drive output 54.

FIG. 7 shows a schematic illustration of a further example embodiment of the second transmission unit 212. The second transmission unit 212 shown in FIG. 7 corresponds substantially to the second transmission unit 212, shown in FIGS. 1 to 6, of the drive apparatus 20 according to the disclosure, and therefore only details and/or points of differentiation will be discussed below. The drive apparatus 20 or axle 100 or work machine 10 illustrated in FIGS. 1 to 4 can comprise the second transmission unit 212 illustrated in FIG. 7. The second transmission unit 212 shown in FIG. 7 corresponds substantially to the second transmission unit 212 shown in FIG. 4, and therefore only details and/or points of differentiation will be discussed below. The second transmission unit 212 comprises the first cylindrical gear stage 320 and the third planetary gear 600. Moreover, the second transmission unit 212 comprises the second and the third and the fourth shift element 324, 326, 602. The second shift element 324 is connected to the first output 204 of the first transmission unit 58, and it is simultaneously designed as the third input 214 of the second transmission unit 212.

The third shift element 326 is connected to the second output 206 of the first transmission unit 58. The first output 204 is connectable by the or by means of the second shift element 324, and the second output 206 is connectable by the third shift element 326, to the third planetary gear 600, for example a component or the same component of the third planetary gear 600, particularly for example the third planet carrier 604 of the third planetary gear 600. The third planetary gear 600, for example the third planet carrier 604 of the third planetary gear 600, is connected to the first cylindrical gear stage 320.

The second output 206 of the first transmission unit 58 is connected to the third planetary gear 600, for example a component of the third planetary gear 600, particularly for example the third sun 606 of the third planetary gear 600. At the same time, the third sun 606 is designed as the fourth input 216 of the second transmission unit 212. In addition, the third shift element 326 can be designed as the fourth input 216 of the second transmission unit 212.

The fourth shift element 602, which is here designed as a brake by way of example, is connectable or connected to the third planetary gear 600, for example a component of the third planetary gear 600, particularly for example the third annulus 608 of the third planetary gear 600. The second and/or third shift element 324, 326 are/is connectable or connected to the drive output 54, for example the output shaft, via the or by means of the first cylindrical gear stage 320. The third planetary gear 600, for example the third planet carrier 604 is likewise connected to the drive output 54 via the or by means of the first cylindrical gear stage 320.

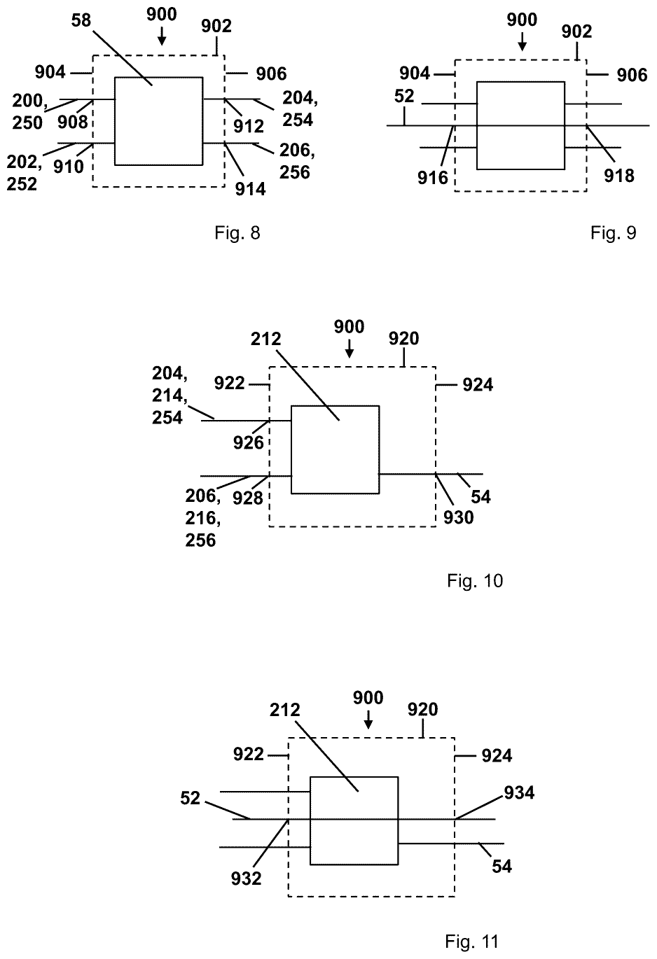

FIG. 8 shows a schematic illustration of a first example embodiment of a gear housing assembly 900 according to the disclosure. The gear housing assembly 900 shown in FIG. 8 can comprise the drive apparatus 20 shown in FIGS. 1 to 7, or components of the drive apparatus 20 according to the disclosure, and therefore only details and/or points of differentiation will be discussed below. The axle 100 or work machine 10 illustrated in FIGS. 1 to 4 can comprise the gear housing assembly 900 illustrated in FIG. 8.

The gear housing assembly 900 comprises a first housing module 902 with the first transmission unit 58. More specifically, the first transmission unit 58 is arranged in the first housing module 902. The first housing module 902 has an input-side housing wall 904 and an output-side housing wall 906. The input-side housing wall 904 of the first housing module 902 has a first and second input opening 908, 910. The output-side housing wall 906 of the first housing module 902 has a first and second output opening 912, 914.

The first input 200, for example the first driving element 250, is arranged in the first input opening 908. More specifically, the first input 200, for example the first driving element 250, can extend through the first input opening 908. As a result, the first input 200, for example the first driving element 250, can be connectable to the first energy machine 56. The second input 202, for example the second driving element 252, is arranged in the second input opening 910. More specifically, the second input 202, for example the second driving element 252, can extend through the second input opening 910. As a result, the second input 202, for example the second driving element 252, can be connectable to the second energy machine 56.

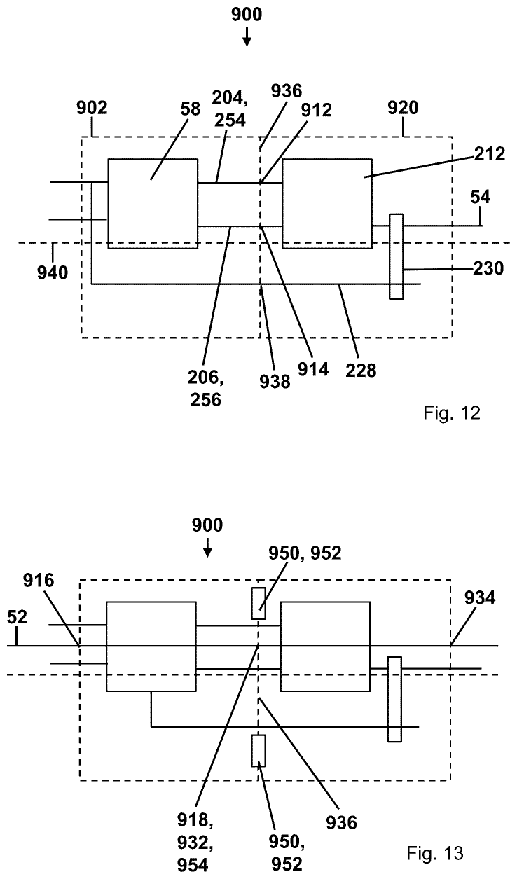

The first output 204, for example the first driven element 254, is arranged in the first output opening 912 of the output-side housing wall 906 of the first housing module 902. More specifically, the first output 204, for example the first driven element 254, can extend through the first output opening 912. As a result, the first output 204, for example the first driven element 254, can be connectable to the second transmission unit 212, for example the third input 214. The second output 206, for example the second driven element 256, is arranged in the second output opening 914. More specifically, the second output 206, for example the second driven element 256, can extend through the second output opening 914. As a result, the second output 206, for example the second driven element 256, can be connectable to the second transmission unit 212, for example the fourth input 214. Moreover, the countershaft 228 can be arranged at least partially in the first housing module 902 (not shown). The countershaft 228 can be arranged in the first input opening 908 or a third input opening of the input-side housing wall 904 of the first housing module 902 (not illustrated). More specifically, the countershaft 228 can extend through the first input opening 908 or the third input opening. In addition, the countershaft 228 can be arranged in a third output opening 930 of the output-side housing wall 906 of the first housing module 902 (see FIG. 12). More specifically, the countershaft 228 can extend through the third output opening 930.

FIG. 9 shows a schematic illustration of a second example embodiment of a gear housing assembly 900 according to the disclosure. The gear housing assembly 900 shown in FIG. 9 can comprise the drive apparatus 20 shown in FIGS. 1 to 7 or components of the drive apparatus 20, for example the first and/or second transmission unit 58, 212 and/or the first and second variators 50, 56 of the drive apparatus 20 according to the disclosure. The gear housing assembly 900 shown in FIG. 9 corresponds substantially to the gear housing assembly 900 shown in FIG. 8, and therefore only details and/or points of differentiation will be discussed below. The axle 100 or work machine 10 illustrated in FIGS. 1 to 4 can comprise the gear housing assembly 900 illustrated in FIG. 9.

The input-side housing wall 904 and the output-side housing wall 906 of the first housing module 902 have a first and second through opening 916, 918, for example a central first and second through opening, for the drive input 52, for example the input shaft. The drive input 52 is arranged in the first and second through openings 916, 918. More specifically, the drive input 52 can extend through the first and second through openings 916, 918. However, it is also possible for a further input-side housing wall and/or a further output-side housing wall of the first housing module 902 to have a first and second through opening 916, 918, for example a central first and second through opening, for the drive input 52, for example the input shaft.

FIG. 10 shows a schematic illustration of a third example embodiment of a gear housing assembly 900 according to the disclosure. The gear housing assembly 900 shown in FIG. 10 can comprise the drive apparatus 20 shown in FIGS. 1 to 7 or components of the drive apparatus 20, for example the first and/or second transmission unit 58, 212 and/or the first and second variators 50, 56 of the drive apparatus 20 according to the disclosure. The gear housing assembly 900 shown in FIG. 10 corresponds substantially to the gear housing assembly 900 shown in FIGS. 8 to 9, and therefore only details and/or points of differentiation will be discussed below. The axle 100 or work machine 10 illustrated in FIGS. 1 to 4 can comprise the gear housing assembly 900 illustrated in FIG. 10.

The gear housing assembly 900 comprises a second housing module 920 with the second transmission unit 212. More specifically, the second transmission unit 212 is arranged in the second housing module 920. The second transmission unit 212 and the drive output 54 can be arranged in the second housing module 920. The second housing module 920 has an input-side housing wall 922 and an output-side housing wall 924. The input-side housing wall 922 of the second housing module 920 has a fourth and fifth input opening 926, 928. The output-side housing wall 924 of the second housing module 920 has a further output opening, for example a fourth output opening 930.

The input-side housing wall 922 of the second housing module 920 has at least one further input opening, for example a fourth input opening 926 or a fourth and fifth input opening 926, 928. The fourth input opening 926 is designed for the attachment and/or connection of the third input 214 of the second transmission unit 212 to the first output 204 of the first transmission unit 58. The fifth input opening 928 is designed for the attachment and/or connection of the fourth input 216 of the second transmission unit 212 to the second output 206 of the first transmission unit 58. The third input 214 and/or the first output 204 are/is arranged in the fourth input opening 926 of the input-side housing wall 922 of the second housing module 920. More specifically, the third input 214, for example the third driving element, and/or the first output 204, for example the first driven element 254, can extend through the fourth input opening 926. The fourth input 216 and/or the second output 206 are/is arranged in the fifth input opening 928 of the input-side housing wall 922 of the second housing module 920. More specifically, the fourth input 216, for example the fourth driving element, and/or the second output 206, for example the second driven element 256, can extend through the fifth input opening 928. The drive output 54, for example the output shaft, is arranged in the fourth output opening 930. More specifically, the drive output 54, for example the output shaft, can extend through the fourth output opening 930.

The countershaft 228 can be arranged in a sixth input opening of the input-side housing wall 922 of the second housing module 920 (not illustrated). More specifically, the countershaft 228 can extend through the sixth input opening.

FIG. 11 shows a schematic illustration of a fourth example embodiment of a gear housing assembly 900 according to the disclosure. The gear housing assembly 900 shown in FIG. 11 can comprise the drive apparatus 20 shown in FIGS. 1 to 7 or components of the drive apparatus 20, for example the first and/or second transmission unit 58, 212 and/or the first and second variators 50, 56 of the drive apparatus 20 according to the disclosure. The gear housing assembly 900 shown in FIG. 11 corresponds substantially to the gear housing assembly 900 shown in FIGS. 8 to 10, and therefore only details and/or points of differentiation will be discussed below. The axle 100 or work machine 10 illustrated in FIGS. 1 to 4 can comprise the gear housing assembly 900 illustrated in FIG. 11.

The input-side housing wall 922 and the output-side housing wall 924 of the second housing module 920 have a third and fourth through opening 932, 934, for example a central third and fourth through opening, for the drive input 52, for example the input shaft. The drive input 52 is arranged in the third and fourth through openings 932, 934. More specifically, the drive input 52 can extend through the third and fourth through openings 932, 934. However, it is also possible for a further input-side housing wall and/or a further output-side housing wall of the second housing module 920 to have a third and fourth through opening 932, 934, for example a central third and fourth through opening, for the drive input 52, for example the input shaft.

FIG. 12 shows a schematic illustration of a fifth example embodiment of a gear housing assembly 900 according to the disclosure. The gear housing assembly 900 shown in FIG. 12 can comprise the drive apparatus 20 shown in FIGS. 1 to 7 or components of the drive apparatus 20, for example the first and/or second transmission unit 58, 212 and/or the first and second variators 50, 56 of the drive apparatus 20 according to the disclosure. The gear housing assembly 900 shown in FIG. 12 corresponds substantially to the gear housing assembly 900 shown in FIGS. 8 to 11, and therefore only details and/or points of differentiation will be discussed below. The axle 100 or work machine 10 illustrated in FIGS. 1 to 4 can comprise the gear housing assembly 900 illustrated in FIG. 12.

The input-side housing wall 904 of the first housing module 902 and the output-side housing wall 924 of the second housing module 920 are designed as a common housing wall 936 of the first and second housing modules 902, 920. The first housing module 902 can be connected to the second housing module 920, for example via the or by the common housing wall 936. The common housing wall 936 of the first and second housing modules 902, 920 has, as common openings, the first and second input openings 912, 914 and the third output opening 930.

The first and second input openings 912, 914 can comprise the fourth and fifth input openings 926, 928 or, in other words, the first and second input openings 912, 914 and the fourth and fifth input openings 926, 928 can be designed as common openings. The third output opening 930 can comprise the sixth input opening or, in other words, the third output opening 930 and the sixth input opening 926, 928 can be designed as common openings.

The first and second outputs 204, 206, for example the first and second driven elements 254, 255, are arranged in the first and second input openings 912, 914 in the common housing wall 936. More specifically, the first and second inputs 204, 206, for example the first and second driven elements 254, 256, can extend through the first and second input openings 912, 914. The first and second housing modules 902, 920 are arranged along a longitudinal axis 940 of the gear housing assembly 900.

The countershaft 228 is arranged in the first and second housing modules 902, 920. In addition, the countershaft 228 is arranged in the third output opening 930 in the common housing wall 936. More specifically, the countershaft 228 can extend through the third output opening 930. Moreover, the drive output 54 and the countershaft 228 can be connectable or connected to one another by the fifth transmission stage 230.

FIG. 13 shows a schematic illustration of a sixth example embodiment of a gear housing assembly 900 according to the disclosure. The gear housing assembly 900 shown in FIG. 13 can comprise the drive apparatus 20 shown in FIGS. 1 to 7 or components of the drive apparatus 20, for example the first and/or second transmission unit 58, 212 and/or the first and second variators 50, 56 of the drive apparatus 20 according to the disclosure. The gear housing assembly 900 shown in FIG. 13 corresponds substantially to the gear housing assembly 900 shown in FIGS. 8 to 12, and therefore only details and/or points of differentiation will be discussed below. The axle 100 or work machine 10 illustrated in FIGS. 1 to 4 can comprise the gear housing assembly 900 illustrated in FIG. 13.

The first housing module 902 is connected to the second housing module 920, for example via the or by the common housing wall 936. The first and second housing modules 902, 920 are connected to one another, for example fastened to one another, particularly for example releasably fastened to one another, by means of or by one or more fastening surfaces 950 and housing flanges 952. The second through opening 918 and the third through opening 932 are designed as a common through opening, for example a central common through opening, in the common housing wall 936.

The drive input 52 is arranged in the first through opening 916, the common through opening 954 and the fourth through opening 934. More specifically, the drive input 52 can extend through the first through opening 916 and the common through opening 954 and the fourth through opening 934.

FIG. 14 shows a detailed schematic illustration of a further example embodiment of the work machine 10 according to the disclosure having a gear housing assembly 900 according to the disclosure. The gear housing assembly 900 shown in FIG. 14 can comprise the drive apparatus 20 shown in FIGS. 1 to 7 or components of the drive apparatus 20, for example the first and/or second transmission unit 58, 212 and/or the first and second variators 50, 56 of the drive apparatus 20 according to the disclosure. The gear housing assembly 900 shown in FIG. 14 corresponds substantially to the gear housing assembly 900 shown in FIGS. 8 to 13, and therefore only details and/or points of differentiation will be discussed below. The axle 100 or work machine 10 illustrated in FIGS. 1 to 4 can comprise the gear housing assembly 900 illustrated in FIG. 14.

FIG. 14 shows schematically two frame elements 960, for example a first and second frame element 962, 964, of the work machine 10. The gear housing assembly 900, for example the first and/or second housing module 902, 920, is/are arranged on, for example between, the two frame elements 960, for example the first and second frame elements 962, 960. The frame elements 960, 962, 964 can be arranged on, for example between or directly adjacent to, the first and second differentials 30, 32. The frame elements 960, 962, 964 can be connected to the first and/or second differentials 30, 32. The gear housing assembly 900, for example the first and/or second housing modules 902, 920, is/are arranged along a longitudinal axis 970 of the work machine 10. The longitudinal axis 940 of the gear housing assembly 900 and the longitudinal axis 970 of the work machine 10 can be identical or parallel.

The terminology used herein is for the purpose of describing example embodiments or implementations and is not intended to be limiting of the disclosure. As used herein, the singular forms “a,” “an,” and “the” are intended to include the plural forms as well, unless the context clearly indicates otherwise. It will be further understood that the use of the terms “has,” “includes,” “comprises,” or the like, in this specification, identifies the presence of stated features, integers, steps, operations, elements, and/or components, but does not preclude the presence or addition of one or more other features, integers, steps, operations, elements, components, and/or groups thereof.

Those having ordinary skill in the art will recognize that terms such as “above,” “below,” “upward,” “downward,” “top,” “bottom,” etc., are used descriptively for the drawings, and do not represent limitations on the scope of the present disclosure, as defined by the appended claims. Furthermore, the teachings may be described herein in terms of functional and/or logical block components or various processing steps, which may include any number of hardware, software, and/or firmware components configured to perform the specified functions.

Terms of degree, such as “generally,” “substantially,” or “approximately” are understood by those having ordinary skill in the art to refer to reasonable ranges outside of a given value or orientation, for example, general tolerances or positional relationships associated with manufacturing, assembly, and use of the described embodiments or implementations.

As used herein, “e.g.,” is utilized to non-exhaustively list examples and carries the same meaning as alternative illustrative phrases such as “including,” “including, but not limited to,” and “including without limitation.” Unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

While the above describes example embodiments or implementations of the present disclosure, these descriptions should not be viewed in a restrictive or limiting sense. Rather, there are several variations and modifications which may be made without departing from the scope of the appended claims.

What is claimed is:

1. A drive apparatus for a work machine, comprising:
a drive input;
a drive output;
a first and second energy machine; and
a first transmission unit having a first and second input and a first and second output;
wherein the drive input is connectable to the drive output via the first transmission unit, the first energy machine is connectable to the first input by a first shift element, and the second energy machine is connected to the second input.

2. The drive apparatus of claim 1, wherein the first transmission unit comprises a planetary coupling gear, for example having two different stationary transmission ratios, and the first transmission unit comprises at least one first and second planetary gear, wherein the planetary gears are coupled to one another.

3. The drive apparatus of claim 1, wherein:
the first input is connectable or connected to a first annulus of the first planetary gear and to a second planet carrier of the second planetary gear,
the second input is connected to a first sun wheel of the first planetary gear,
the first output is connectable or connected to a first planet carrier of the first planetary gear and to a second annulus of the second planetary gear, and
the second output is connected to the second sun of the second planetary gear.

4. The drive apparatus of claim 1, wherein the first energy machine is designed as a first electric motor, and the second energy machine is designed as a second electric motor.

5. The drive apparatus of claim 1, wherein the drive apparatus comprises a second transmission unit including a first cylindrical gear stage and a second cylindrical gear stage and a third planetary gear, and at least one second and third shift element, and the second transmission unit has two inputs and at least one third output.

6. The drive apparatus of claim 5, wherein the second transmission unit is arranged downstream of the first transmission unit in the power flow.

7. The drive apparatus of claim 1, wherein the drive apparatus comprises power electronics.

8. The drive apparatus of claim 5, wherein the first and second transmission units have a passage for the drive input.

9. The drive apparatus of claim 1, wherein the first energy machine is connectable to a first power output.

10. The drive apparatus of claim 1, wherein the drive output and the first transmission unit are connectable to a countershaft.

11. The drive apparatus of claim 1, wherein the drive apparatus comprises a control unit.

12. An axle comprising the drive apparatus of claim 1.

13. A gear housing assembly comprising the drive apparatus of claim 1, wherein the gear housing assembly comprises a first housing module with the first transmission unit, wherein the first housing module has an input-side housing wall and an output-side housing wall, and the input-side housing wall of the first housing module has at least one first input opening, and the output-side housing wall of the first housing module has a first output opening, and the gear housing assembly comprises a second housing module with the second transmission unit, wherein the second housing module has an input-side housing wall and an output-side housing wall, and the input-side housing wall of the second housing module has at least one further input opening, and the output-side housing wall of the second housing module has at least one further output opening.

14. A work machine comprising the gear housing assembly of claim 13.

15. The work machine of claim 14, wherein the work machine comprises two frame elements, wherein the gear housing assembly is arranged at least partially on the frame elements.
